(19) United States
(12) Patent Application Publication
(10) Pub. No.: US 2026/0020043 A1
(43) Pub. Date: Jan. 15, 2026

(54) METHOD, USER EQUIPMENT AND ACCESS NETWORK NODE

(71) Applicant: NEC Corporation, Minato-ku, Tokyo (JP)

(72) Inventors: Yinan QI, Guíldford (GB); Pravjyot DEOGUN, Milton Keynes (GB); Caroline LIANG, Guíldford (GB)

(73) Assignee: NEC Corporation, Minato-ku, Tokyo (JP)

(21) Appl. No.: 18/992,220

(22) PCT Filed: Jul. 31, 2023
(86) PCT No.: PCT/JP2023/027988

§ 371 Date: Jan. 8, 2025

(30) Foreign Application Priority Data
Aug. 12, 2022 (GB) 2211854.1

(51) Int. Cl. H04W 72/25; H04L 5/00; H04W 72/0446

(52) U.S. Cl. CPC H04W 72/25; H04L 5/0051; H04W 72/0446

(57) ABSTRACT

A user equipment (UE) is disclosed that receives, from another UE, information related to at least one resource configuration for direct UE-to-UE positioning reference signal (PRS) transmission by the another UE. The UE selects at least one resource, for transmission of at least one direct UE-to-UE PRS, based on the information, and transmits the at least one direct UE-to-UE PRS using the at least one resource.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to the allocation of resources for sidelink positioning in new radio (NR) communication systems.

### BACKGROUND ART

Previous developments of the 3GPP standards include those referred to as the Long Term Evolution (LTE) of Evolved Packet Core (EPC) network and Evolved UMTS Terrestrial Radio Access Network (E-UTRAN), also commonly referred as ‘4G’. More recently, the term ‘5G’ and ‘new radio’ (NR) has been used to refer to an evolving communication technology that is expected to support a variety of applications and services such as MTC/IoT communications, vehicular communications and autonomous cars, high resolution video streaming, smart city services, and/or the like. Various details of 5G networks are described in, for example, NPL 1. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’, or ‘base station’) via which communication devices (user equipment or ‘UE’) connect to a core network and communicate to other communication devices or remote servers. Communication between the UEs and the base station is controlled using the so-called Radio Resource Control (RRC) protocol. For simplicity, the present application will use the term RAN node or base station to refer to any such access nodes.

In the current 5G architecture, the gNB structure may be split into two parts known as the Central Unit (CU) and the Distributed Unit (DU), connected by an F1 interface. This enables the use of a ‘split’ architecture, whereby the, typically ‘higher’, CU layers (for example, but not necessarily or exclusively), the Packet Data Convergence Protocol (PDCP) layer) and the, typically ‘lower’, DU layers (for example, but not necessarily or exclusively, radio link control (RLC) layer/media access control (MAC) layer/physical (PHY) layer) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present application will use the term communication device, user device, or UE to refer to any communication device that is able to connect to the core network via one or more base stations. Although the present application may refer to mobile or user devices in the description, it will be appreciated that the technology described can be implemented on any communication devices (mobile and/or generally stationary) that can connect to a communications network for sending/receiving data, regardless of whether such communication devices are controlled by human input or software instructions stored in memory. For example, such a communication device may be operable by a human or may be a partially or fully automated (MTC/IoT) device.

The ability to accurately locate the position of a UE has long been an important and developing part of cellular communication technology. Originally driven by regulatory requirements for emergency calls, cellular positioning technology has been developed to provide significant improvements in accuracy, coverage extent (both indoors and outdoors), latency, reliability etc.

Positioning in 5G is anticipated to support many and varied positioning use cases, each coming with its own respective performance requirements. These use cases include, for example: enhanced indoor navigation (e.g., in shopping malls, hospitals, or underground facilities); tracking of unmanned (autonomous) vehicles; public safety applications (e.g., assisting first responders to reach emergencies more quickly, or monitoring the location of vulnerable people); smart factories; localised sensing; digital twins; augmented/virtual reality; etc.

Positioning methods supported in 5G include, amongst other things: RAT-dependent methods including Observed Time Difference Of Arrival (OTDOA) based positioning; Uplink Time Difference of Arrival (UTDOA) based positioning; Roundtrip time (RTT) based positioning; Angle of Arrival (AOA) based positioning; and RAT-independent methods including Global Navigation Satellite System (GNSS) based positioning; barometric sensor based positioning; and Bluetooth based positioning.

New reference signals and related measurements have been introduced in 5G to support enhanced (e.g., more accurate/precise) NR positioning related measurements (compared to LTE). These signals include newly defined dedicated positioning reference signals (PRS) for positioning in the downlink and sounding reference signals (SRS) for positioning in the uplink. For example, a UE can perform downlink reference signal time difference (DL RSTD) measurements for each base station's PRSs and report these to the location server for downlink positioning. Similarly, each base station can measure the uplink relative time of arrival (UL-RTOA) and report the measurements to the location server for uplink positioning. Moreover, channel state information reference signals (CSI-RS) and synchronisation signal blocks (SSBs) can also be used (e.g., as part of an enhanced cell ID (E-CID) positioning method).

More recent NR developments include: the provision of positioning for UEs in the RRC inactive state; on-demand transmission and reception of downlink PRS; enhancements for angle based methods; enhancements of information reporting from the UE, and the base station, for supporting mitigation of multipath/non-line of sight (NLOS) effects; enhancements of signalling and procedures for reducing positioning latency; and signalling and procedures to support global navigation satellite system (GNSS) positioning integrity.

Current communication technology also provides various ways in which UEs can communicate data between each other directly without using resources of a base station (although in some cases the UEs will require at least some control signalling from the base station). Such communications are often referred to as UE-to-UE direct communications, Device-to-Device (D2D) communications or sidelink communications. D2D communications were originally defined as part of Proximity Services (ProSe) services in Release 12 and Release 13 of the 3GPP specifications. As part of ProSe services, a new D2D interface was introduced. This D2D interface is referred to as ‘PC5’, or ‘Sidelink’ at the physical layer. Sidelink provides a direct link for communications between devices, with or without network coverage. As D2D technology has been developed, sidelink has been further enhanced for vehicular use cases, addressing high speed (up to 250 km/h along roads and up to 500 km/h along railways) and high density (thousands of nodes) scenarios as well.

Sidelink has several application areas/use cases, such as proximity services, public safety, IoT, including machine type communication and sensors, wearable devices, amongst others. The term Vehicle-to-Everything (V2X) covers a special application area of Sidelink/PC5 for the purpose of communications between vehicles using a direct link. V2X encompasses at least the following categories: Vehicle-to-Vehicle (V2V); Vehicle-to-Infrastructure (V2I); Vehicle-to-Pedestrian (V2P); Vehicle-to-Home (V2H); and enhanced Vehicle-to-Everything (eV2X).

As sidelink communication involves direct communication between UEs, it supports a range of use cases in which a UE is not necessarily within coverage of a base station. These use cases include: in-coverage use cases in which a given pair of UEs involved in sidelink communication are both in coverage of the base station, partial-coverage use cases in which one of the UEs involved in the sidelink communication is in coverage of the base station while another of the UEs involved in the sidelink communication is not in coverage of the base station; and out-of-coverage use cases in which neither of a given pair of UEs involved in sidelink communication are in coverage of the base station. Of course, a given UE may move between in-coverage, partial coverage, and out-of-coverage scenarios.

Many of these sidelink use cases require positioning and so there is a general need to develop techniques and enhancements for supporting sidelink positioning. In order to develop such techniques and enhancements for supporting sidelink positioning due consideration needs to be given to the specific scenarios and/or requirements that sidelink positioning potentially needs to support. The coverage scenarios for consideration include, for example, the various coverage scenarios introduced above (in-coverage, partial-coverage, and out-of-coverage). The various use cases for consideration include, for example, such as (e)V2X use cases (e.g., as discussed in NPL 2), public safety use cases (e.g., as also discussed in NPL 2), commercial use cases (e.g., as discussed in NPL 3), and/or industrial internet of things (IIOT) use cases (e.g., as discussed in NPL4). The requirements for consideration include, for example, those identified in in NPL 2, NPL 3, and/or NPL4. Moreover, consideration needs to be given to the spectrum that may be used for sidelink use cases including both dedicated intelligent transportation systems (ITS) spectrum the spectrum licensed to mobile network operators (including FR2).

Sidelink communication between UEs uses physical channels that are analogous to corresponding physical channels used for communication between the base station and a UE. These sidelink physical channels include a Physical Sidelink Shared Channel (PSSCH) and a Physical Sidelink Control Channel (PSCCH). Control information for controlling sidelink communication, referred to as sidelink control information (SCI), may be sent directly between UEs. SCI is sent in two parts (referred to as ‘stages’). The 1st stage is carried by a PSCCH and the 2nd stage is carried by a corresponding PSSCH, which is associated with the PSCCH.

When a UE is in-coverage of a base station, the base station is able to assign and manage the resources used for sidelink communications (e.g., V2V communications or the like), from that UE to another UE, using base station to UE communication over the air interface (e.g., the so-called Uu interface). In NR this network managed type of resource allocation is known as mode 1 resource allocation, although it is similar a type of resource allocation known as mode 3 in LTE (for V2X). In the network-controlled resource allocation sidelink radio resources can be allocated from sidelink dedicated licensed carriers or from licensed carriers that share resources between the UE-UE sidelink and the UE-base station uplink. In NR, scheduling for the network-controlled resource allocation mode (mode 1) may involve dynamic grant (DG) scheduling (as in LTE V2X mode 3 scheduling) or configured grant (CG) scheduling (whereas LTE V2X mode 3 uses semi-persistent scheduling).

In the DG scheduling, a UE respectively requests resources from the base station for the transmission each transport block (TB) (and for each possible blind or hybrid automatic repeat request (HARQ) retransmission). Specifically, the UE transmits a scheduling request (SR) to the base station in the uplink using a physical uplink control channel (PUCCH). The base station responds with downlink control information (DCI), using a physical downlink control channel (PDCCH), that indicates the allocated sidelink resources (e.g., time resources in the form of one or more slots and frequency resources in the form of one or more sub-channels). The allocated sidelink resources may be used for the transmission of the TB and up to two possible retransmissions of the same TB. Accordingly, while DG scheduling provides a high resource scheduling flexibility, and a relatively low latency, the need to request resources nevertheless introduces some delay and increases signalling overhead.

In CG scheduling, the base station assigns a set of sidelink resources (referred to as the configured grant (CG)) to a UE that can be used (persistently or semi-persistently) for transmitting several TBs. The CG is configured using a set of parameters that includes a CG index, at least one time-frequency allocation, and the periodicity of the allocated SL resources. To support CG scheduling, the UE may provide the base station with UE assistance information. Accordingly, CG scheduling has the potential to provide a reduced signalling overhead and latency compared to DG, albeit at the expense of resource scheduling flexibility.

When a UE is out-of-coverage of any base station, the network is unable to assign and manage the resources used for sidelink communications. To allow sidelink communication by UE that is out-of-coverage, therefore, the UE can apply an autonomous resource selection technique. In NR this autonomous type of resource selection is known as mode 2 resource allocation, although it is similar a type of resource allocation known as mode 4 in LTE (for V2X). Specifically, when operating in the autonomous resource selection mode, a UE can autonomously select sidelink resources (one or several sub-channels) from a resource pool that may be preconfigured and/or configured by the base station when the UE is in network coverage. NR autonomous mode (mode 2) resource allocation supports a dynamic scheduling scheme and a semi-persistent scheduling scheme. When using the dynamic scheme the UE selects new resources for each TB and can only reserve resources (by notifying in-range UEs) for future retransmissions of that TB. The semi-persistent scheme can be enabled, or disabled, in a given resource pool by a (pre)configuration. When a UE reserves a resource for future transmission it notifies nearby (‘neighbouring’) UEs using 1st stage SCI that is sent directly from one UE to another using a physical sidelink control channel (PSCCH). When using the semi-persistent scheduling scheme a UE can select and reserve resources for the transmission of several TBs (and their retransmissions).

In the autonomous mode a UE select new sidelink resources when it generates a new TB. Selection can also be triggered for the semi-persistent scheme when a new TB is too large to be sent in previously reserved resources. To select new sidelink resources (either dynamic or semi-persistent), a UE initially defines a time interval (corresponding to a range of slots), referred to as a selection window, including resources (referred to as candidate resources) from which new sidelink resources are selected for transmission of a TB.

When the UE is not transmitting, it performs a sensing operation to identify candidate resources that are available. The sensing operation is performed during a time interval, referred to as a sensing window, corresponding to range of slots. During the sensing process, the UE decodes 1st stage SCI received from other UEs in the sensed sidelink resources. The respective 1st-stage SCI received from each UE indicates the sidelink resources reserved for retransmissions of a TB associated with the 1st-stage SCI, and resources reserved for the initial transmission and retransmissions of the next TB. The UE also measures the transmissions (e.g., reference signal received power (RSRP)) associated with respective 1st stage SCI received from other UEs. The UE stores the sensed information (the decoded 1st stage SCI and the RSRP measurements) and determines, based on the sensed information, which candidate resources from the selection window should be excluded when a new selection is triggered (and hence those candidate resources that are available for selection).

Sidelink radio resources can be configured so that network controlled (mode 1) resource allocation and autonomous (mode 2) resource selection use different resource pools. However, sidelink radio resources can also be configured so that network controlled (mode 1) resource allocation and autonomous (mode 2) resource allocation share the same resource pool. Pool sharing has the benefit of potentially greater resource efficiency albeit at the expense of conflict (e.g., potential collisions) between transmissions scheduled using the different modes.

To address this, a UE operating in network-controlled resource allocation mode notify other, autonomous resource selection mode UEs, of the resources allocated for their future (re)transmissions, for example using the 1st stage SCI that is sent directly from one UE to another using the PSCCH as described above.

### CITATION LIST

### Non Patent Literature

NPL 1: ‘NGMN 5G White Paper’ V1.0 by the Next Generation Mobile Networks (NGMN) Alliance, <https://www.ngmn.org/5g-white-paper.html>
NPL 2: 3GPP TR 38.845 V1.0.1
NPL 3: 3GPP TS 22.261 V18.3.0
NPL 4: 3GPP TS 22.104 V18.3.0

### SUMMARY OF INVENTION

### Technical Problem

In order to support positioning involving sidelink, it has been proposed to introduce sidelink positioning reference signals (SL-PRS or S-PRS)—i.e., positioning reference signals transmitted/received in the sidelink and used for positioning purposes. There is, therefore, a need for efficient methods for configuring and scheduling resources for such SL-PRS signals.

The disclosure aims to provide apparatus and related methods aimed at contributing, at least partially, to meeting one or more of the above needs.

### Solution to Problem

In one aspect the disclosure provides a method performed by a user equipment (UE), the method comprising: receiving, from another UE, information related to at least one resource configuration for direct UE-to-UE positioning reference signal (PRS) transmission by the another UE; selecting at least one resource, for transmission of at least one direct UE-to-UE PRS, based on the information; and transmitting the at least one direct UE-to-UE PRS using the at least one resource.

The information may indicates at least one of: at least one frequency resource reserved for the direct UE-to-UE PRS transmission; a frequency offset for a resource reserved for the direct UE-to-UE PRS transmission; a number of symbols, for the direct UE-to-UE PRS transmission, per slot; or a comb pattern for the direct UE-to-UE PRS transmission.

The information may be received periodically in accordance with a periodicity. The information may indicate the periodicity. The information may be received in a first stage, the information may indicate that further information will be transmitted in a second stage, and the method further comprises receiving the further information. The further information may include at least one parameter related to at least one of: muting, or repetition, to be applied in respect of at least one direct UE-to-UE PRS to be transmitted by the another UE. The information may be received periodically in accordance with a first periodicity, and the further information is received in accordance with a second periodicity that is different to the first periodicity. The information may indicate activation or deactivation of the at least one resource configuration. The method may further comprise communicating with the another UE to identify at least one shared resource for transmission by the UE of at least one direct UE-to-UE PRS that is multiplexed with transmission by the another UE of at least one other direct UE-to-UE PRS.

In one aspect the disclosure provides a method performed by a user equipment (UE), the method comprising: transmitting, to an access network node, assistance information for assisting allocation of at least one resource for direct UE-to-UE positioning reference signal (PRS) transmission; receiving, from the access network node, an allocation of at least one resource for direct UE-to-UE PRS transmission based on the assistance information; and transmitting the at least one direct UE-to-UE PRS using the at least one resource.

The assistance information may indicate at least one of: an availability of the UE to be used as anchor node; a velocity of the UE; a heading of the UE; or a current location of the UE. The allocation of at least one resource for direct UE-to-UE PRS transmission may be an allocation at least one shared resource for multiplexed transmission of at least one direct UE-to-UE PRS with transmission by another UE of at least one other direct UE-to-UE PRS.

In one aspect the disclosure provides a method performed by a user equipment (UE), the method comprising: transmitting, to another UE, information related to at least one resource configuration for direct UE-to-UE positioning reference signal (PRS) transmission by the UE, for selection, by the another UE, of at least one resource for transmission of at least one direct UE-to-UE PRS, based on the information; and receiving the at least one direct UE-to-UE PRS using the at least one resource.

In one aspect the disclosure provides a method performed by an access network node, the method comprising: receiving, from a UE, assistance information for assisting allocation of at least one resource for direct UE-to-UE positioning reference signal (PRS) transmission; and transmitting, to the UE, an allocation of at least one resource for direct UE-to-UE PRS transmission based on the assistance information.

In one aspect the disclosure provides a user equipment (UE) comprising: means for receiving, from another UE, information related to at least one resource configuration for direct UE-to-UE positioning reference signal (PRS) transmission by the another UE; means for selecting at least one resource, for transmission of at least one direct UE-to-UE PRS, based on the information; and means for transmitting the at least one direct UE-to-UE PRS using the at least one resource.

In one aspect the disclosure provides a user equipment (UE) comprising: means for transmitting, to another UE, information related to at least one resource configuration for direct UE-to-UE positioning reference signal (PRS) transmission by the UE, for selection, by the another UE, of at least one resource for transmission of at least one direct UE-to-UE PRS, based on the information; and means for receiving the at least one direct UE-to-UE PRS using the at least one resource.

In one aspect the disclosure provides a method performed by an access network node, the method comprising: means for receiving, from a UE, assistance information for assisting allocation of at least one resource for direct UE-to-UE positioning reference signal (PRS) transmission; and means for transmitting, to the UE, an allocation of at least one resource for direct UE-to-UE PRS transmission based on the assistance information.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 illustrates a typical configuration of a sidelink resource pool that may be used in the telecommunication system of FIG. 1;

FIG. 4A illustrate a different type of slot format that may be used in the telecommunication system 1;

FIG. 4B illustrate a different type of slot format that may be used in the telecommunication system 1;

FIG. 5 is a simplified sequence diagram illustrating an exemplary dynamic grant procedure that may be implemented in in the telecommunication system of FIG. 1;

FIG. 6 is a simplified sequence diagram illustrating an exemplary configured grant procedure that may be implemented in in the telecommunication system of FIG. 1;

FIG. 7 is a simplified illustration of how different CGs may be configured in the telecommunication system of FIG. 1;

FIG. 8 is a simplified illustration of how autonomous mode resource selection may operate in the telecommunication system of FIG. 1;

FIG. 9 is a simplified schematic block diagram illustrating the main components of a UE for the telecommunication system of FIG. 1;

FIG. 10 is a simplified schematic block diagram illustrating the main components of a base station for the telecommunication system of FIG. 1;

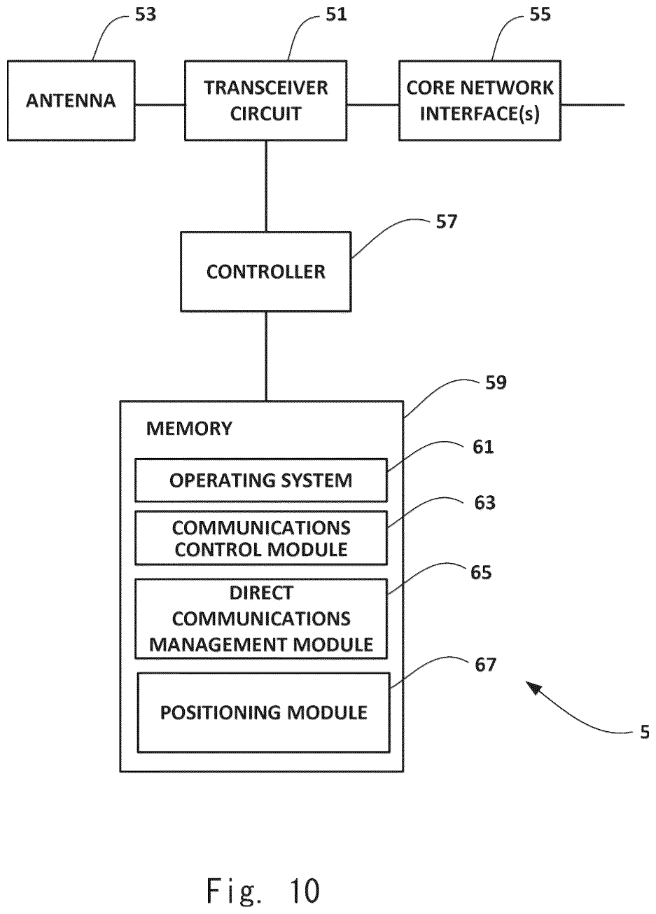

FIG. 11 is a simplified sequence diagram illustrating a procedure involving the transfer of sidelink control information between two UEs for the telecommunication system of FIG. 1;

FIG. 12A is a simplified illustration of a respective way in which sidelink downlink control may be provided in the telecommunication system of FIG. 1;

FIG. 12B is a simplified illustration of a respective way in which sidelink downlink control may be provided in the telecommunication system of FIG. 1;

FIG. 13A is a simplified illustration of another respective way in which sidelink downlink control may be provided in the telecommunication system of FIG. 1;

FIG. 13B is a simplified illustration of another respective way in which sidelink downlink control may be provided in the telecommunication system of FIG. 1;

FIG. 14 is a simplified sequence diagram illustrating a way in which UE may be provided in the telecommunication system of FIG. 1;

FIG. 15 is a simplified sequence diagram illustrating a method for resource allocation/selection in the telecommunication system of FIG. 1;

FIG. 16 is a simplified illustration of multiplexing of three different UEs in the telecommunication system of FIG. 1;

FIG. 17 is a simplified sequence diagram illustrating methods for joint resource the telecommunication system of FIG. 1;

FIG. 18 is a simplified illustration of an application of a method illustrated in FIG. 17; and

FIG. 19 is a simplified illustration of an application of a method illustrated in FIG. 17.

### DESCRIPTION OF EXAMPLE EMBODIMENTS

### Overview

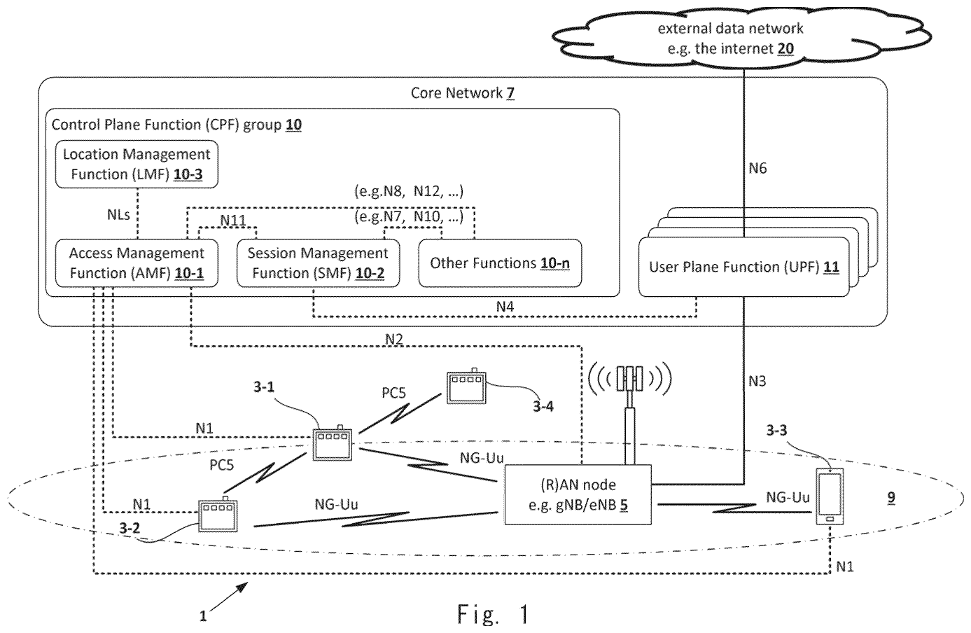

An exemplary telecommunication system will now be described in overview, by way of example only, with reference to FIGS. 1 to 8.

FIG. 1 schematically illustrates a mobile (‘cellular’ or ‘wireless’) telecommunication system 1 to which example embodiments of the present disclosure are applicable.

In the network 1 user equipment (UEs) 3-1, 3-2, 3-3, 3-4 (e.g., mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g., a 5G core network or evolved packet core network (EPC)).

As those skilled in the art will appreciate, whilst four UEs 3 and one base station 5 are shown in FIG. 1 for illustration purposes, the system, when implemented, will typically include other base stations and UEs.

Each base station 5 controls one or more associated cells either directly, or indirectly via one or more other nodes (such as home base stations, relays, remote radio heads, distributed units, transmission reception points (TRPs) and/or the like). It will be appreciated that the base stations 5 may be configured to support both 4G and 5G, and/or any other 3GPP or non-3GPP communication protocols.

The UEs 3 and their serving base station 5 are connected via an appropriate air interface (for example the so-called ‘NG-Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2, a one or more Location Management Function (LMFs) 10-3, and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the Si reference point in LTE). It will be appreciated, that N1 communications are routed transparently via the base station 5.

One or more UPFs 11 are connected to an external data network 20 (e.g., an IP network such as the internet) via reference point N6 for communication of the user data.

The AMF 10-1 performs mobility management related functions, maintains the non-NAS signalling connection with each UE 3 and manages UE registration. The AMF 10-1 is also responsible for managing paging. The SMF 10-2 is connected to the AMF 10-1 via an NIl reference point. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The LMF 10-3 manages the support of different location services for UEs 3 whose location is unknown and needs to be located (‘target UEs’), including positioning of the UEs 3 and delivery of assistance data to the UEs 3. The LMF 10-3 may interact with a serving base station 5 for a target UE 3 in order to obtain position measurements for that UE 3, including uplink measurements made by the base station (e.g., of SRS) and downlink measurements made by the UE 3 (e.g., of PRS /SL-PRS) and provided to the base station 5. The LMF 10-3 may interact with a target UE 3 in order to deliver assistance data if requested for a particular location service, or to obtain a location estimate if requested.

For positioning of a target UE 3, the LMF 10-3 decides on the position methods to be used, based on factors that may include, for example, a location services (LCS) client type, a required quality of service (QoS), UE positioning capabilities, and/or base station positioning capabilities. The LMF 10-3 can invoke these positioning methods in the UE 3 and/or serving base station. The positioning methods may yield a location estimate for UE-based position methods and/or positioning measurements for UE-assisted and network-based position methods. The LMF 10-3 may combine the received results and determine a single location estimate for the target UE 3. Additional information like accuracy of the location estimate and velocity may also be determined.

The LMF 10-3 is connected to the AMF 10-1 via an NLs reference point. The LMF 10-3 is configured to receive measurement results (e.g., for PRS) and assistance information from the base station 5 and/or UEs 3, via the AMF 10-1 over the NLs interface, and to compute the position of the UEs 3 based on the measurement results. The communication of positioning information between the base station 5 and the LMF 10-3 makes use of an appropriate protocol (such as the NR Positioning Protocol A (NRPPa)). The LMF 10-3 is also configured for configuring the UEs 3 using an appropriate protocol (e.g., the LTE positioning protocol (LPP)) via AMF 10-1.

The base station 5 is configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on the physical uplink shared channel PUSCH. The PBCH provides UEs 3 with the Master Information Block, MIB. It also, in conjunction with the PDCCH, supports the synchronisation of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), positioning reference signal (PRS) as described earlier, and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, a physical uplink shared channel (PUSCH), a physical uplink control channel (PUCCH), and/or a physical random access channel (PRACH). The UL physical signals may include, for example, demodulation reference signals (DMRS) for a UL control/data signal, and/or sounding reference signals (SRS) used for UL channel measurement and/or measurements for UL positioning.

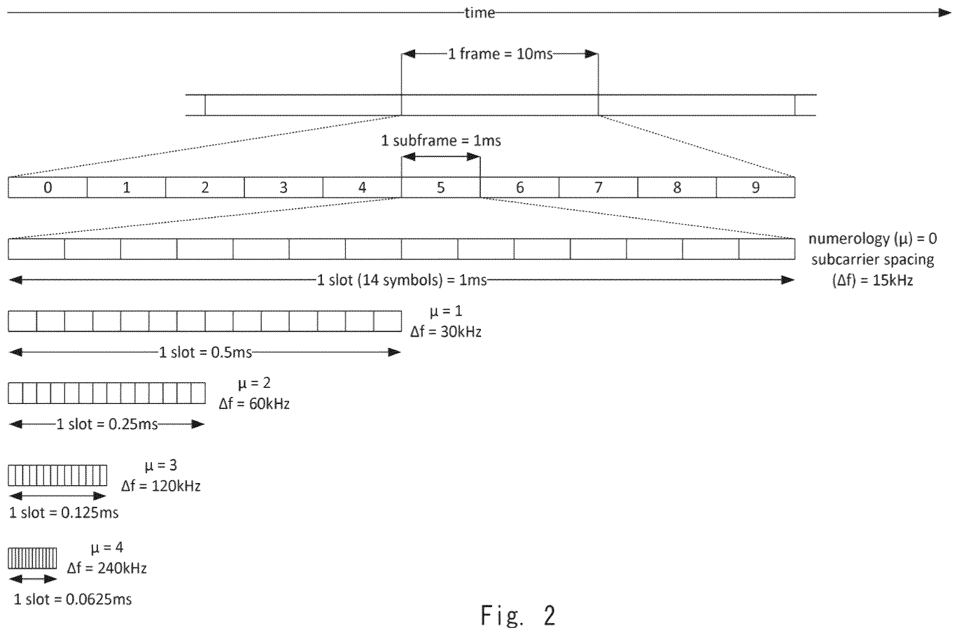

Referring to FIG. 2, which illustrates the typical frame structure that may be used in the telecommunication system 1, the base station 5 and UEs 3 of the telecommunication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the telecommunication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e., SCS=15×2^{μ} kHz). The relationship between the parameter, μ, and SCS (Δf) is as shown in Table 1:

TABLE 1
5G Numerology

| | | Number of slots | Slot length |
|---|---|---|---|
| μ | Δf = 2^{μ} · 15[kHz] | per subframe | (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

In the communication system 1 the cell bandwidth can be divided into multiple bandwidth parts (BWPs) that each start at a respective starting resource block (RB) and respectively comprises of a set of contiguous RBs with a given numerology (sub-carrier spacing, ‘SCS’, and cyclic prefix, ‘CP’) on a given carrier. By defining a small BWP for a UE 3, the computational complexity and power consumption of that UE 3 can be reduced. As each BWP can have a different bandwidth and numerology, BWPs enable flexible and efficient use of resources by dividing the carrier bandwidth for multiplexing transmissions with different configurations and requirements.

The UEs 3 and base station 5 of the communication system 1 are thus configured for operation using BWPs. For each serving cell of a UE 3, the base station 5 can configure at least one downlink (DL) BWP (e.g., an initial DL BWP). The base station 5 may configure the UE 3 with up to a maximum (typically four) further DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g., an initial UL BWP). The base station 5 may configure the UE 3 with up to a maximum (typically four) further UL BWPs with only one UL BWP being active at a given time. The UE 3 does not transmit PUSCH or PUCCH outside an active bandwidth part. For an active cell, the UE 3 does not transmit SRS outside an active bandwidth part.

A BWP identifier or index (BWP-ID) is used to refer to BWPs (in UL and DL independently). Various radio resource control (RRC) configuration procedures can thus use the BWP-ID to associate themselves with a particular BWP.

The UEs 3 and base station 5 are configured to support positioning in the telecommunication system 1, for example by transmitting appropriate reference signals (e.g., SRS in the uplink and PRS in the downlink respectively), and by performing appropriate measurements on those reference signals (e.g., PRS in the downlink and SRS in the uplink respectively) and reporting the results to the LMF 10-3 for position determination. A UE 3 may, for example, perform measurements of the times at which reference signals (e.g., PRS) are received from different base stations 5 to determine downlink reference signal time difference (DL RSTD) for the purposes of DL time difference of arrival (DL-TDOA) based positioning. A UE 3 may, for example, perform measurements of downlink reference signal receive power (DL RSRP) per beam/base station for use in determining the downlink angle of departure (DL AoD) based on UE beam location for each base station. The LMF 10-3 can then use the AoDs to estimate the UE position. A base station 5 may, for example, perform measurements of the times at which reference signals (e.g., SRS) are received at the base station 5 to determine uplink relative time of arrival (UL RTOA) for the purposes of UL time difference of arrival (UL-TDOA) based positioning. A base station 5 may, for example, perform measurements of an angle of arrival of received reference signals based on a beam the UE Is located in for the purposes of UL angle of arrival (UL-AOA) based positioning. The UE 3 and base station 5 may also perform receiver transmitter (Rx-Tx) time difference measurements for signals in each cell. Measurement reports including the results of these measurements from the UE 3 and base station 5 can then be used by the LMF 10-3 to derive corresponding round trip times (RTTs) for the purposes of multi-cell RTT based positioning.

In the telecommunication system 1, at least some of the UEs 3-1, 3-2, and 3-4 are capable of performing direct (UE-to-UE)—or ‘sidelink’—communication between one another, via a direct UE-to-UE interface (e.g., the ‘sidelink’ or ‘PC5’ interface) when in range. This direct communication may be: in-coverage sidelink communication involving a pair of UEs 3-1, 3-2 that are both in coverage of the base station 5 (e.g., as illustrated between UEs 3-2 and 3-1); partial-coverage sidelink communication involving a UE 3-1 that is in coverage of the base station 5 and a UE 3-4 that is not in coverage of the base station 5 (e.g., as illustrated between UEs 3-4 and 3-1); or out-of-coverage sidelink communication involving a pair of UEs 3-4 that are both outside the coverage of the base station 5.

The sidelink capable the UEs 3-1, 3-2, 3-4 are configured for communication via a number of dedicated sidelink physical channels and transmission/reception of a number of SL physical signals. The sidelink physical channels include the Physical Sidelink Broadcast Channel (PSBCH), the Physical Sidelink Feedback Channel (PSFCH), the Physical Sidelink Shared Channel (PSSCH), and the Physical Sidelink Control Channel (PSCCH).

The PSBCH carries the sidelink broadcast transport channel (SL-BCH) which is used for periodic transmission (e.g., every 160 ms) of a Master Information Block (MIB) for sidelink. The MIB carries system information for UE-to-UE communication. The information carried by the PSBCH is transmitted with a Sidelink Primary Synchronization Signal/Sidelink Secondary Synchronization Signal (S-PSS/SSS) as part of a sidelink-synchronization signal block (S-SSB).

The PSFCH is used for transmission of hybrid automatic repeat request (HARQ) feedback from a receiver UE 3-1, 3-2, 3-4 to a transmitter UE 3-1, 3-2, 3-4 on the SL for a unicast or groupcast communication.

The PSSCH contains transport blocks (i.e., user data traffic) of the sidelink shared transport channel (SL-SCH) and is typically associated with a PSCCH transmitted in the same slot.

The sidelink capable UEs 3-1, 3-2, 3-4 are able to send sidelink control information (SCI) in two stages for general sidelink communication. The 1st stage is carried by a PSCCH, and the 2nd stage is carried by a corresponding PSSCH, which is associated with the PSCCH.

A UE 3-1, 3-2, 3-4 may use the 1st stage SCI to inform other UEs 3-1, 3-2, 3-4 of resources allocated by the base station for a particular dynamic grant (DG)/configured grant (CG) period (e.g., in mode 1) or autonomously selected by the UE (e.g., in mode 2). A UE 3-1, 3-2, 3-4 may use the 2nd-stage SCI to inform other UEs 3-1, 3-2, 3-4 of information to be used for decoding the PSSCH, and for supporting HARQ feedback and CSI reporting.

The first-stage SCI may contain, for example, information to enable sensing operations, information about the resource allocation of the PSSCH, and, when needed, an indication that the UE can receive conflict information in inter-UE coordination. The 1st stage SCI typically includes, for example: a frequency resource (e.g., sub-channels) assignment for the PUSCH; a time resource assignment; a resource reservation period for up to two further transmissions an associated TB; a priority for the associated PUSSCH; a demodulation reference signal (DMRS) pattern; information identifying a 2nd-stage SCI format and size; a modulation and coding scheme of the data payload carried in the associated PSSCH; one or more reserved bits; a beta offset indicator; and/or a number of a DMRS port.

The second-stage SCI can carry information needed to identify and decode the associated SL-SCH, as well as control for HARQ procedures, triggers for channel state information (CSI) feedback, inter-UE coordination requests and information, etc. The 2nd stage SCI typically includes, for example: a HARQ process ID; a new data indicator; a redundancy version; a source ID; a destination ID; and/or a CSI request.

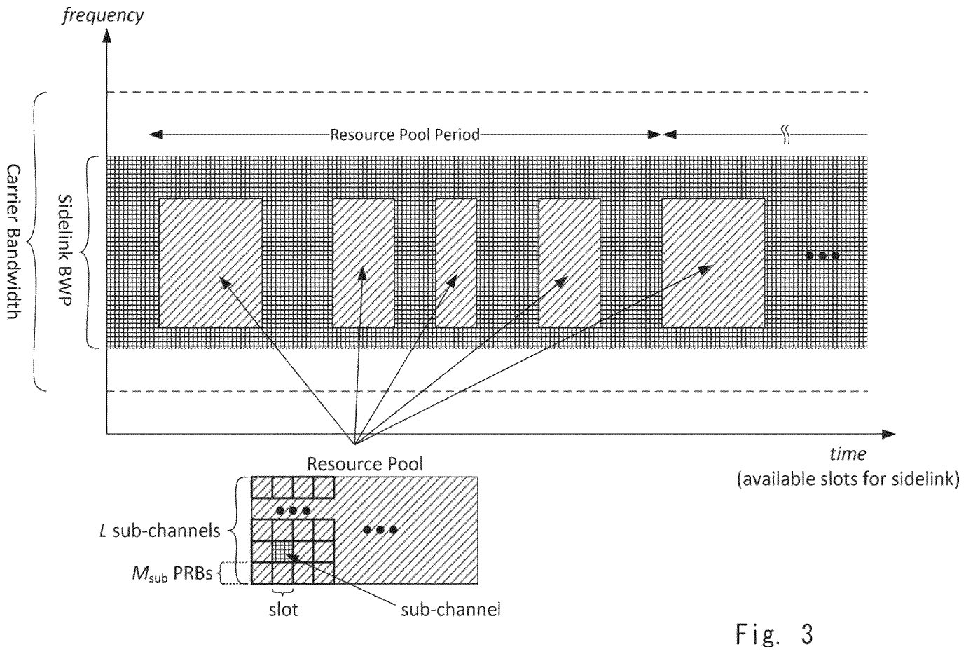

Referring to FIG. 3, which illustrates a typical configuration of a sidelink resource pool that may be used in the telecommunication system of FIG. 1, the base station 5 is able to configure at least one respective dedicated sidelink BWP (SL-BWP) for each of the sidelink capable UEs 3-1, 3-2, 3-4. Each SL BWP occupies a contiguous portion of the bandwidth within the component carrier on which the cell 9 is provided. Sidelink transmissions and receptions for a given UE 3-1, 3-2, 3-4 will be contained within the SL BWP configured for that UE 3-1, 3-2, 3-4 and will employ the same numerology. Thus, all physical channels, reference signals and synchronization signals in the sidelink are transmitted within the corresponding SL BWP. This also means that, in the sidelink, a UE 3-1, 3-2, 3-4 is not expected to receive or to transmit using more than one numerology. The SL BWP is divided into common RBs where a common RB consists of 12 consecutive subcarriers with the same SCS, where the SCS is given by the numerology of the SL BWP.

The communication resources available for sidelink comprise time resources (e.g., sots) and frequency resources (e.g., common RBs) within a SL BWP. A subset of these available sidelink resources may be preconfigured/configured to be used by one or more UEs 3-1, 3-2, 3-4 for their sidelink communication (transmissions/receptions). This subset of available resources may be referred to as a ‘resource pool’.

A given UE 3-1, 3-2, 3-4 can be preconfigured/configured with a plurality of resource pools including one or more resource pools for transmission (TX resource pools) and with one or more resource pools for reception (RX resource pools). Accordingly, a UE 3-1, 3-2, 3-4 is able to receive data on resource pools used for SL transmissions by other UEs 3-1, 3-2, 3-4, while the UE 3-1, 3-2, 3-4 can still transmit on the sidelink using its transmit resource pools. A resource pool can be used for all transmission types (for example, unicast, groupcast, and/or broadcast).

The common resource blocks within a resource pool may also be referred to as physical resource blocks (PRBs). As seen in FIG. 3, the illustrated resource pool consists of contiguous PRBs and contiguous, or non-contiguous, slots that have been preconfigured/configured for sidelink communication. The resource pool is defined to be within the SL BWP and so a single numerology is used within the resource pool. If a UE 3-1, 3-2, 3-4 has been configured with an active UL BWP, then the SL BWP will also use the same numerology as the UL BWP if they both BWPs are on the same carrier.

The resource pool is divided, in the frequency domain, into a preconfigured/configured number (‘L’) of contiguous sub-channels (representing the smallest frequency unit for sidelink data transmission/reception), where each sub-channel comprises a group of consecutive PRBs in a slot. The size of the sub-channel (in units of PRBs) is given by ‘M_{sub}’ and may be preconfigured/configured to be any suitable size (for example, 10, 12, 15, 20, 25, 50, 75, or 100 PRBs). Each sidelink transmission may use one or multiple sub-channels.

In the time domain, the slots that are part of a resource pool are preconfigured/configured and occur with a pre-set periodicity corresponding to a resource pool period (the resource pool period is typically, for example, 10240 ms). The slots that form the resource pool may be preconfigured/configured, for example by means of a bitmap which may be any suitable length (for example 10, 11, 12, . . . , 160 bits).

A number of different techniques for implementing SL-PRS using appropriate resource pools may be used. For example, one or more dedicated resource pools may be (pre)configurable at the UE 3-1, 3-2, 3-4 for the transmission/reception of SL-PRS and/or for transmission/reception of measurement reports carrying the results of measurements of the SL-PRS. In this case a given dedicated SL-PRS resource pool may be (pre)configured as a transmitter (Tx) resource pool for transmission of SL-PRS or as a receiver (Rx) resource pool for reception of SL-PRS. Similarly, a given dedicated measurement report resource pool may be (pre)configured as a transmitter (Tx) resource pool for transmission of measurement reports or as a receiver (Rx) resource pool for reception of measurement reports. The resources of one or more pre(configured) shared sidelink resource pools may be used for the transmission/reception of SL-PRS and conventional sidelink (data) communication. Where dedicated resource pools are (pre)configurable, one or more separate dedicated resource pools may respectively be (pre)configured for transmission/reception of SL-PRS and for transmission/reception of measurement reports. In this case the SL-PRS resource pool will typically include SL-PRS transmissions without any transmissions of measurement reports or other data. Nevertheless, a PSCCH carrying first stage SCI and a PSSCH carrying second stage SCI could potentially be included with the SL-PRS within one time slot.

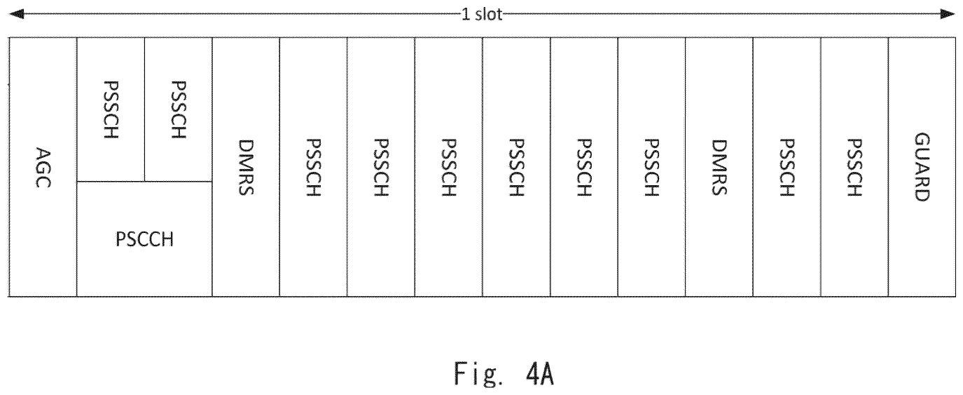

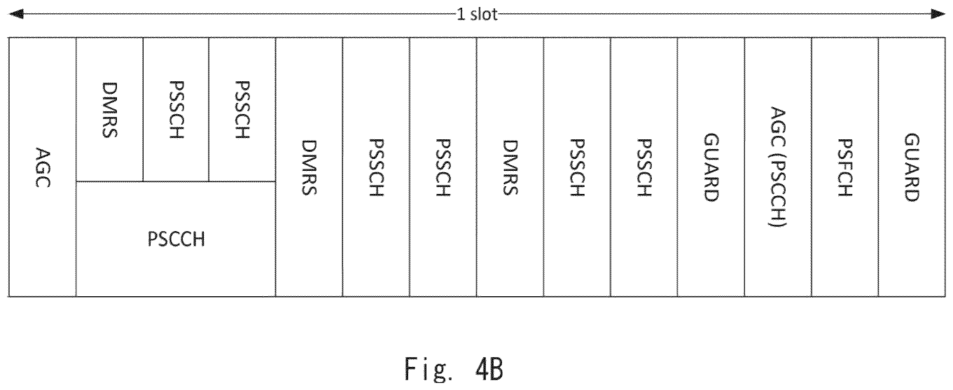

FIGS. 4A and 4B respectively illustrate a different type of slot format that may be used in the telecommunication system 1. As seen in FIGS. 4A and 4B, each slot can include PSSCH, PSCCH, PSFCH, automatic gain control (AGC) and guard symbols. The AGC and guard symbols are sent as specific symbols. AGC symbols may be used for level control in a sidelink receiver whereas guard symbols may be used as guard periods for switching between sidelink reception and transmission. Guard symbols are placed as immediate symbols after PSSCH, PSFCH, or S-SSB.

The PSSCH is transmitted in consecutive symbols of a slot. The start symbol and the number of symbols to transmit the PSSCH are configured by a higher layer, (e.g., media access control (MAC)). A PSSCH cannot be transmitted in the same symbols that are configured for the transmission of PSFCH or the last symbol of the slot, which is configured as a place holder for a guard symbol.

Each sidelink UE 3-1, 3-2, 3-4 and the base station 5 are mutually configured for operation in a network managed resource allocation mode (e.g., mode 1 resource allocation) resource allocation (e.g., when the UE 3-1, 3-2, 3-4 is in coverage of the base station 5). Scheduling in the network-controlled resource allocation mode may involve dynamic grant (DG) scheduling or may involve configured grant (CG) scheduling.

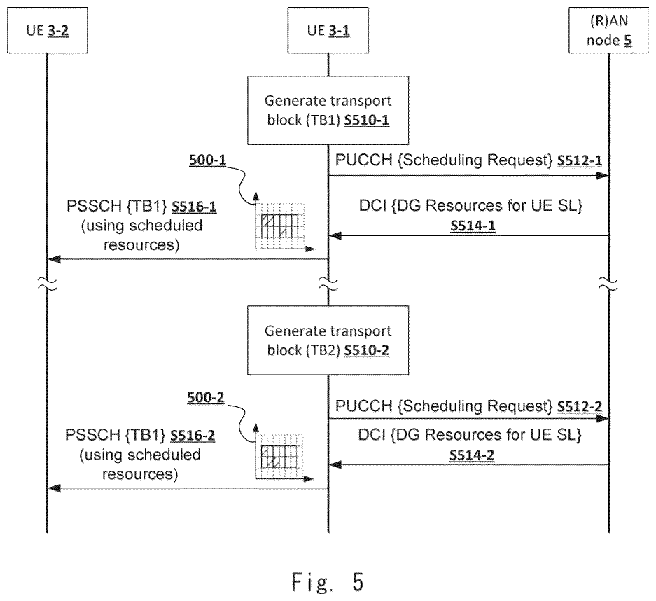

The network managed resource allocation mode will now be described, by way of example only, with reference to FIGS. 5 to 7.

FIG. 5 is a simplified sequence diagram illustrating an exemplary dynamic grant procedure that may be implemented in the communication system 1.

As seen in FIG. 5, in the illustrated example, dynamic grant is used for transmitting two TBs (TB1 and TB2). When the UE 3-1, 3-2, 3-4 generates a transport block (TB1) at S510-1, the UE 3-1, 3-2, 3-4 sends a scheduling request (e.g., on the PUCCH) to the base station 5 at S512-1 to request resources for transmitting TB1. The base station 5 responds, at S514-1 with downlink control information (DCI) indicating the resources 500-1 for the UE 3-1, 3-2, 3-4 to use for transmission of TB1 (and up to two possible retransmissions). The UE 3-1, 3-2, 3-4 can then use the scheduled resources 500-1, at S516-1, to transmit TB1 (e.g., using the PSSCH). A similar process takes place when another transport block (TB2) is generated at S510-2. Specifically, the UE 3-1, 3-2, 3-4 sends another scheduling request (e.g., on the PUCCH) to the base station 5 at S512-2 to request resources 500-2 for transmitting TB2. The base station 5 responds, at S514-2 with downlink control information indicating the resources 500-2 for the UE 3-1, 3-2, 3-4 to use for transmission of TB2 (and up to two possible retransmissions). The UE 3 can then use the scheduled resources 500-2, at S516-2, to transmit TB2 (e.g., using the PSSCH).

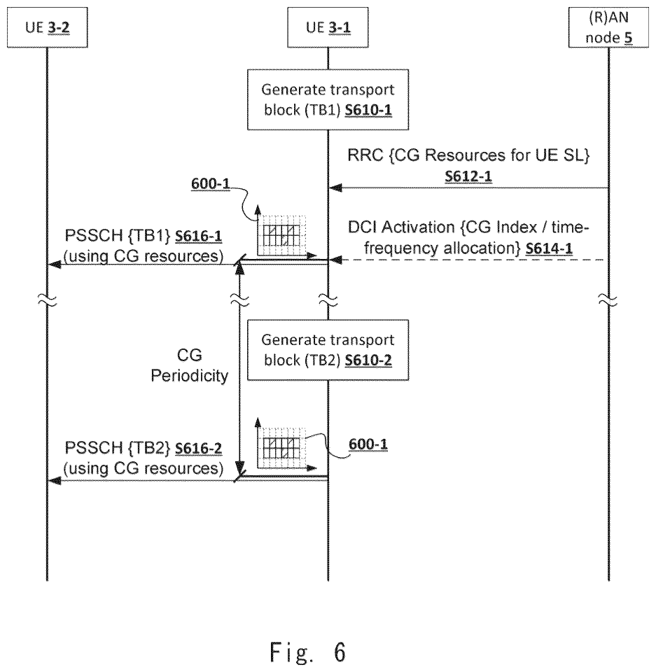

FIG. 6 is a simplified sequence diagram illustrating an exemplary configured grant procedure that may be implemented in the communication system 1.

As seen in FIG. 6, in the illustrated example, configured grant is used for transmitting two TBs (TB1 and TB2). When the UE 3-1, 3-2, 3-4 generates a transport block (TB1) at S610-1, the UE 3-1, 3-2, 3-4 does not request resources as it would for a dynamic grant, but waits until the base station 5 provides, at S612-1, a configured grant (CG) to the UE 3-1, 3-2, 3-4 to use for transmission of data (e.g., using radio resource control (RRC) signalling). The CG defines a set of resources 600-1 to be assigned periodically to the UE 3. The CG is configured using a set of parameters that includes the CG index, a time-frequency resource allocation and a periodicity of the allocated sidelink resources 600-1.

There are two possible two types of CG that may be used by the base station 5 and UE 3-1, 3-2, 3-4—CG type 1 and CG type 2. Both may be configured using RRC signalling (as illustrated at S612-1). For CG type 1 the resources 600-1 of the CG can be used immediately by the UE 3-1, 3-2, 3-4 until that CG is released by the base station 5 (also using RRC signalling). For CG type 2 the resources 600-1 of the CG can be used by the UE 3-1, 3-2, 3-4 only after the CG is activated, as indicated at S614-1, by the base station 5 (e.g. using DCI signalling). Once activated the type 2 CG remains active until deactivated (e.g. using DCI signalling). In this case the activation/deactivation DCI may also include the CG index and time-frequency allocation for CG type 2. Once the CG is received (and activated in the case of CG type 2), the UE 3-1, 3-2, 3-4 can then use the scheduled resources 600-1, at S616-1, to transmit TB1 (e.g., using the PSSCH).

When another transport block (TB2) is generated at S610-2, the UE 3-1, 3-2, 3-4 waits until the CG period is completed (i.e., when the resources 600-1 of the configured grant are effectively reassigned) before using the scheduled resources 600-1, at S616-2, to transmit TB2 (e.g., using the PSSCH). The time period configured for a CG may be adjusted to be equal to (or near equal to) the time expected between TBs based on information indicated by the UE 3-1, 3-2, 3-4 (for example, in UE assistance information).

The CG scheme reduces the time needed to transmit the two TBs compared to DG. However, the DG scheme has the potential for greater resource efficiency, especially when handling non-periodic traffic (since resources are only allocated when specifically needed for TB transmission).

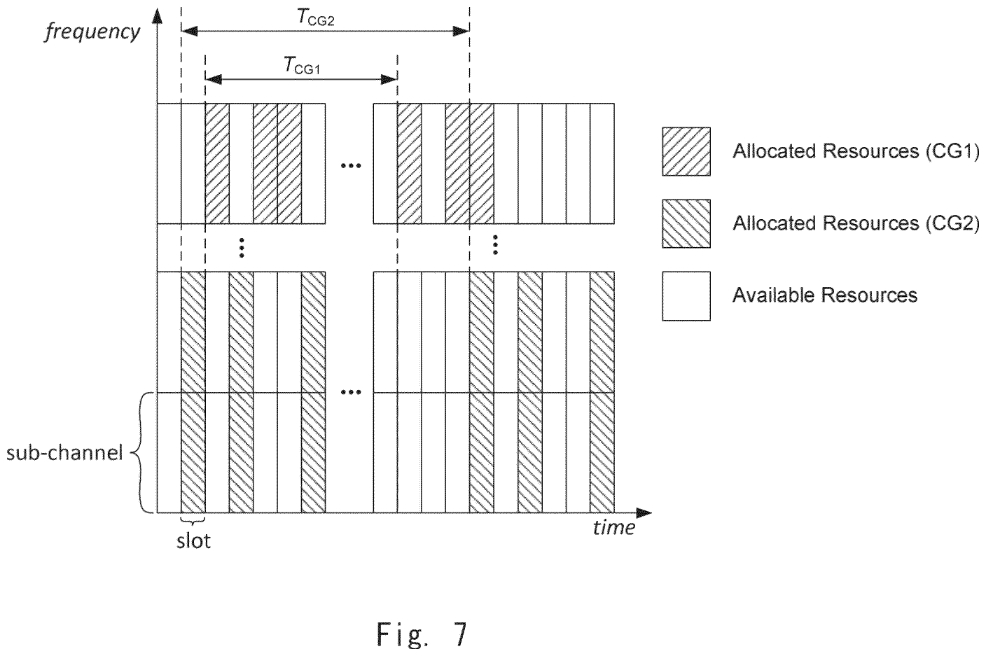

Referring to FIG. 7, which is an illustrative example of how different CGs may be configured in the communication system 1, CG type 2 can be used to configure a plurality of different CGs for a UE 3-1, 3-2, 3-4. For CG type 2, a subset of the configured CGs may be activated for a UE 3-1, 3-2, 3-4 based on the requirements of that UE 3-1, 3-2, 3-4 (while resources in other, non-active, CGs may be allocated to other UEs). CG type 1 can also be used to configure a plurality of CGs but, in this case, the UE has to activate the different CGs at the time of their configuration. Accordingly, while CG type 1 reduces the signalling and the time needed to initiate a transmission compared to CG type 2, if any of plural CG type 1 CGs are not used by a UE, those resources are not available for use by other UEs.

To support scheduling in the network managed resource allocation mode (mode 1), the UE 3-1, 3-2, 3-4, may provide the base station 5 with UE assistance information. The UE assistance information may indicate, for example, sidelink related information from which the base station 5 can infer expected sidelink traffic characteristics. The UE assistance information typically includes, for example: a periodicity for the TBs in the sidelink, a TB maximum size, and Quality of Service information. The QoS information may include, for example, KPIs such as the latency and reliability required by the TBs and their priority. The base station 5 can then use the UE assistance information to identify an appropriate CG that meets expected future sidelink traffic requirements.

The base station 5 can use the UE assistance information to identify a CG for uplink communication that best matches the characteristics and requirements of the traffic over the air interface. The UE assistance information may also be used to improve sidelink UE to network (e.g., vehicle to network) communications where communication in the sidelink, and communication over the air interface with the base station 5, share the same radio resources. The base station 5 may, for example, use UE assistance information about sidelink traffic characteristics for scheduling uplink transmissions to the base station 5 and to identify adequate CGs for uplink communication that minimise interference to sidelink communication. The UE assistance information reported to the base station 5 may include information for network managed mode (mode 1) or autonomous mode (mode 2) sidelink scheduling. The UE assistance information may include, for example, information about the sidelink traffic (e.g., a sidelink channel busy ratio for the sidelink resource pool), UE-related location/mobility information (e.g., position, speed). The base station 5 may, for example, use location information to determine in the network manage resource allocation mode, that the same resources can be assigned to different UEs because those UEs are sufficiently distanced from one another (or to avoid assignment of the same resources to UEs that are relatively close). In the case of autonomous mode, sidelink scheduling, location/mobility information could be used, for example, to allocate the same resource pool to sidelink UEs that are approaching one another.

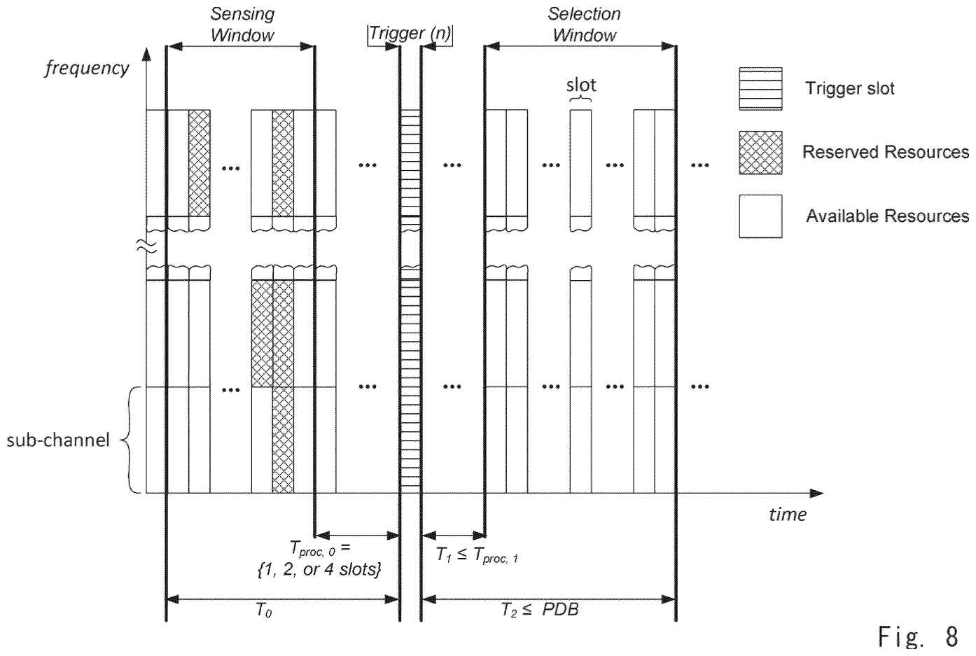

Each sidelink UE 3-1, 3-2, 3-4 is also configured for operation in an autonomous resource selection mode (e.g., mode 2 resource selection) in which the UE 3-1, 3-2, 3-4 can autonomously select sidelink resources (one or several sub-channels) from a resource pool (e.g., when the UE 3-1, 3-2, 3-4 is not in coverage of the base station 5). The autonomous allocation mode will now be described, by way of example only, with reference to FIG. 8, which is a simplified illustration of how autonomous mode resource selection may operate in the telecommunication system of FIG. 1.

Specifically, when operating in the autonomous resource selection mode, a UE 3-1, 3-2, 3-4 can autonomously select sidelink resources (one or several sub-channels) from the resource pool (that may be preconfigured and/or configured by the base station when the UE 3-1, 3-2, 3-4 is in network coverage). NR autonomous mode (mode 2) resource allocation supports a dynamic scheduling scheme and a semi-persistent scheduling scheme. When using the dynamic scheme the UE 3-1, 3-2, 3-4 selects new resources for each TB and can only reserve resources (by notifying in-range UEs) for future retransmissions of that TB. The semi-persistent scheme can be enabled, or disabled, in a given resource pool by a (pre)configuration. When a UE 3-1, 3-2, 3-4 reserves a resource for future transmission it notifies nearby (‘neighbouring’) UEs using 1st stage SCI that is sent directly from one UE to another using a physical sidelink control channel (PSCCH). When using the semi-persistent scheduling scheme a UE 3-1, 3-2, 3-4 can select and reserve resources for the transmission of several TBs (and their retransmissions).

In the autonomous mode a UE select new sidelink resources when it generates a new TB. Selection can also be triggered for the semi-persistent scheme when a new TB is too large to be sent in previously reserved resources. To select new sidelink resources (either dynamic or semi-persistent), a UE 3-1, 3-2, 3-4 initially defines a time interval (corresponding to a range of slots), referred to as a selection window, including resources (referred to as candidate resources) from which new sidelink resources are selected for transmission of a TB.

When the UE is not transmitting, it performs a sensing operation to identify candidate resources that are available. The sensing operation is performed during a time interval, referred to as a sensing window, corresponding to range of slots. During the sensing process, the UE decodes 1st stage SCI received from other UEs 3-1, 3-2, 3-4 in the sensed sidelink resources. The respective 1st-stage SCI received from each UE 3-1, 3-2, 3-4 indicates the sidelink resources reserved for retransmissions of a TB associated with the 1st-stage SCI, and resources reserved for the initial transmission and retransmissions of the next TB. The UE 3-1, 3-2, 3-4 also measures the transmissions (e.g., reference signal received power (RSRP)) associated with respective 1st stage SCI received from other UEs 3-1, 3-2, 3-4. The UE 3-1, 3-2, 3-4 stores the sensed information (the decoded 1st stage SCI and the RSRP measurements) and determines, based on the sensed information, which candidate resources from the selection window should be excluded when a new selection is triggered (and hence those candidate resources that are available for selection).

When selecting resources from the selection window to be used for transmission, the UE may use a two-step procedure. In the first step the UE 3-1, 3-2, 3-4 restricts the candidate resources available for selection be excluding candidate resources from the selection window that have either been reserved or for which the UE 3-1, 3-2, 3-4 is unable to determine whether a reservation has been made. For example, the UE 3-1, 3-2, 3-4 excludes candidate resources in the selection window that it may not have received a corresponding reservation for (e.g., because the UE 3-1, 3-2, 3-4 was transmitting at the time the corresponding reservations would have been announced by another UE 3-1, 3-2, 3-4). The UE 3-1, 3-2, 3-4 also excludes the candidate resources reserved by other UEs 3-1, 3-2, 3-4 in corresponding 1st stage SCIs detected and decoded during the sensing window (subject to a measured RSRP associated with the reservation exceeding a threshold). In the second step the UE 3-1, 3-2, 3-4 performs a random selection of the sidelink resources from the list of available candidate resources (i.e., those remaining after the exclusion step).

The start of the selection window, T₁, is defined by reference to the time resource (slot), n, at which new resource (re)selection is triggered (and selection of resources commences) and the processing time (in units of slots), T_{proc,1}, required by the UE to identify candidate resources and select new sidelink resources for transmission. The end (and hence the size) of the selection window, T₂, (relative to the (re)selection trigger) is dependent on UE implementation but must be smaller than the packet delay budget (PDB) in units of slots.

The end of the sensing window is defined by reference to the time resource (slot), n, at which the next new resource (re)selection is triggered and the time (in units of slots), T_{proc,0}, required to complete the sensing procedure (typically equal to one slot for an SCS of 15 or 30 kHz, and equal to 2 or 4 slots for a SCS of 60 or 120 kHz, respectively). The start of the sensing window (and hence its size) is defined by reference to an integer, T₀, defined in number of slots (before the trigger n). T₀ depends on the SCS configuration (e.g., having a value, in number of slots, that is equivalent to 1100 ms or 100 ms). The selected value may determine based on the (pre)configuration of the resource pool.

The sidelink capable UEs 3-1, 3-2, 3-4 and base station 5 of the communication system 1 are configured for supporting sidelink based positioning. Specifically, the UEs 3-1, 3-2, 3-4 are configured for transmitting, receiving, measuring, and reporting, via the base station 5, sidelink positioning reference signals (SL-PRS). In particular, the sidelink capable UEs 3-1, 3-2, 3-4 can be configured by the base station 5, and/or can be preconfigured, with one or more resource pools from which resources for transmission and/or reception of SL-PRS can be allocated.

A number of different beneficially techniques for supporting sidelink based positioning, and in particular, efficient resource allocation/selection for SL-PRS are described in more detail later, by way of example only. These exemplary techniques include, for example, use of an SL-PRS specific sidelink control information SCI design, use of SL-PRS specific sidelink UE assistance information, resource allocation/selection for multiplexing of SL-PRS from different UEs, and joint/combined resource allocation/selection for SL-PRS for a plurality of UEs. It will be appreciated, for completeness, that the each of the different techniques for supporting sidelink based positioning described in this document has the potential to provide benefits in the communication system in its own right. It is not therefore essential that every technique is implemented albeit that the techniques are not mutually exclusive and can, therefore, be implemented in the same communications system.

### User Equipment

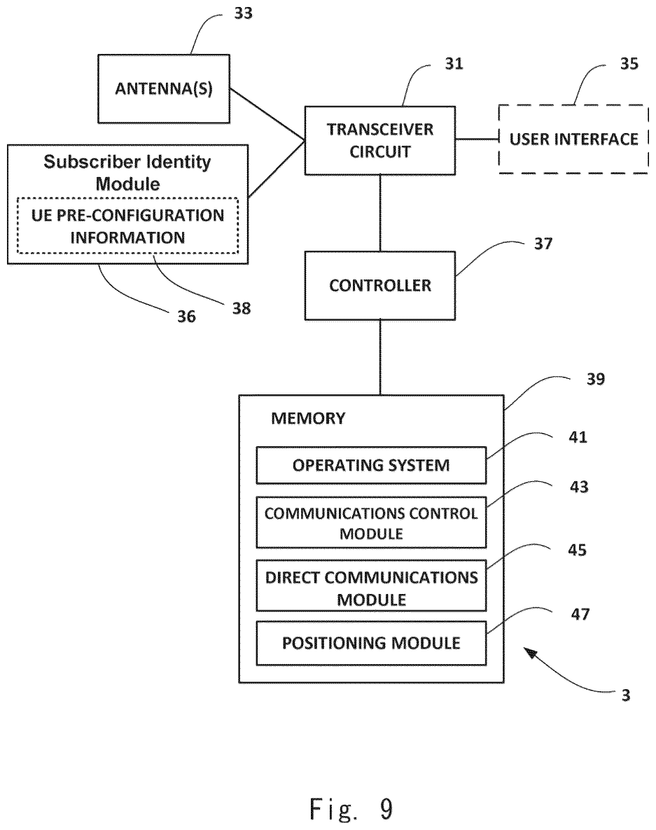

FIG. 9 is a schematic block diagram illustrating the main components of a UE 3 for the communication system 1 shown in FIG. 1. In this example the UE 3 is a UE that is capable of performing sidelink communication.

As shown, the UE 3 has a transceiver circuit 31 that is operable to transmit signals to and to receive signals from a base station 5 via one or more antenna 33. The UE 3 includes a subscriber identity module (SIM) 36 which may be implemented in any suitable manner, for example physically (e.g., as a universal integrated circuit card (UICC) or the like) or virtually (e.g., as an embedded SIM (eSIM) or the like). The UE 3 also has a controller 37 to control the operation of the UE 3. The controller 37 is associated with a memory 39 and is coupled to the transceiver circuit 31.

Although not necessarily required for its operation, the UE 3 might, of course, have all the usual functionality of a conventional UE 3 (e.g., a user interface 35, such as a touch screen/keypad/microphone/speaker and/or the like for, allowing direct control by and interaction with a user) and this may be provided by any one or any combination of hardware, software, and firmware, as appropriate. Software may be pre-installed in the memory 39 and/or may be downloaded via the telecommunications network or from a removable data storage device (RMD), for example.

In addition to subscriber information and security information (such as the UE's international mobile subscriber identity (IMSI) and encryption keys), the SIM 36 can store UE pre-configuration information 38 for preconfiguring the UE 3. This pre-configuration information may include, for example, pre-configuration information for configuring one or more resource pools at the UE 3 (e.g., dedicated SL-PRS or measurement report resource pools) that can be applied by the UE 3 autonomously (without network involvement).

The controller 37 is configured to control overall operation of the UE 3 by, in this example, program instructions or software instructions stored within memory 39. As shown, these software instructions include, among other things, an operating system 41, a communications control module 43, a direct communications module 45, and a positioning module 47.

The communications control module 43 is operable to control the overall communication between the UE 3 and its one or more serving base stations 5 (and other communication devices connected to the base station 5, such as further UEs and/or core network nodes). The communications control module 43 handles, for example, the generation/sending/receiving of signalling messages and sidelink/uplink/downlink data packets between the UE 3 and other nodes and devices. The signalling may comprise control signalling (e.g., via system information or RRC) related to UE positioning. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an IP sub-module, an RRC sub-module, etc. The communications control module 43 is also responsible for the overall handling uplink communications via associated uplink channels (e.g., via a physical uplink control channel (PUCCH) and/or a physical uplink shared channel (PUSCH)) including both dynamic and semi-static signalling (e.g., SRS). The communications control module 43 is also configured for the overall handling of receipt of downlink communications via associated downlink channels (e.g., via a physical downlink control channel (PDCCH) and/or a physical downlink shared channel (PDSCH)) including both dynamic and semi-static signalling (e.g., PRS). The communications control module 43 is responsible for determining the resources to be used by the UE 3, to determine how frequency resources and/or slots/symbols are configured (e.g., for UL communication, DL communication, or the like), and to determine which one or more bandwidth parts are configured for the UE 3.

The direct communications module 45 operates under the overall control of the communications control module 43 and is responsible for direct UE-to-UE (i.e., sidelink) communication. The direct UE-to-UE communication includes, for example, the transmission/reception of SL-PRS and the transmission/reception of SL-PRS associated measurement reports. The direct UE-to-UE communication may be based, for example, on control information/configuration information received (e.g., via the communications control module 43) from the base station 5 (e.g., in downlink control information (DCI) provided in the PDCCH, RRC or MAC signalling), or from other UEs 3 (e.g., in sidelink control information (SCI) provided in the PSCCH or PSSCH, or in RRC signalling sent/transferred via the PC5 interface (e.g., using PC5-RRC signalling)). It will nevertheless be appreciated that the direct UE-to-UE communication may be based fully or partially on configuration information obtained from the SIM 36 (e.g., stored as UE pre-configuration information 38). The direct communications module 45 is also responsible for determining, based on the control information/configuration information, the resource pools (shared and/or dedicated) and associated resources within those pools to be used by the UE 3 for direct UE-to-UE communication including the transmission/reception of SL-PRS, and/or the transmission/reception of SL-PRS associated measurement reports.

The positioning module 47 is responsible for positioning related procedures including, for example performing measurements and generating associated measurement reports (e.g., time difference of arrival and/or the like) in respect of sidelink positioning reference signals SL-PRS from another UE, and in respect of PRS from the serving base station and/or other base stations.

The positioning module 47 may communicate (via the direct communications module 45) with other UEs 3 over an appropriate UE-to-UE interface such as Sidelink/PC5. The positioning module 47 may also communicate (via the communications control module 43) with the base station 5 and/or a positioning function entity in the core network 7 such as the LMF 10-3. Such communication with the positioning function entity may, for example, be used for assisting the UE 3 to determine the UE's location (or the location of another device) and/or to provide the location to the UE 3 (if determined by the positioning function entity itself).

### Base Station

FIG. 6 is a schematic block diagram illustrating the main components of the base station 5 for the communication system 1 shown in FIG. 1. As shown, the base station 5 has a transceiver circuit 51 for transmitting signals to and for receiving signals from the communication devices (such as UEs 3) via one or more antenna 53 (e.g., an antenna array/massive antenna), and a core network interface 55 (e.g., comprising the N2, N3 and other reference points/interfaces) for transmitting signals to and for receiving signals from network nodes in the core network 7. Although not shown, the base station 5 may also be coupled to other base stations via an appropriate interface (e.g., the so-called ‘Xn’ interface in NR). The base station 5 has a controller 57 to control the operation of the base station 5. The controller 57 is associated with a memory 59. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within memory 59.

As shown, these software instructions include, among other things, an operating system 61, a communications control module 63, a direct communications management module 65, and a positioning module 67.

The communications control module 63 is operable to control the communication between the base station 5 and UEs 3 and other network entities that are connected to the base station 5. The communications control module 63 is configured for the overall control of the reception of uplink communications, via associated uplink channels (e.g., via a physical uplink control channel (PUCCH) and/or a physical uplink shared channel (PUSCH)) including both dynamic and semi-static signalling (e.g., SRS). The communications control module 63 is also configured for the overall handling of the transmission of downlink communications via associated downlink channels (e.g., via a physical downlink control channel (PDCCH) and/or a physical downlink shared channel (PDSCH)) including both dynamic and semi-static signalling (e.g., PRS).

The direct communications management module 65 is responsible for managing network-controlled aspects of direct UE-to-UE (i.e., sidelink) communication (e.g., for an in-coverage UE or an out-of-coverage UE that is communicating with an in-coverage UE in a partial coverage sidelink scenario). The direct communications module 65 is responsible, for example, for managing the transmission control information/configuration information for direct UE-to-UE communication to a UE 3 (e.g., in downlink control information (DCI) provided in the PDCCH, RRC or MAC signalling) possibly for relaying by a recipient UE to an out-of-coverage UE (e.g., via the PC5 interface (e.g., PC5-RRC signalling)). The control information/configuration information may include, for example, information for configuring the resource pools (shared and/or dedicated) and/or for allocating associated resources within those pools to be used by the UE 3 for direct UE-to-UE communication (including, for example, the transmission/reception of SL-PRS, and/or the transmission/reception of SL-PRS associated measurement reports).

The positioning module 67 is responsible for network side positioning related procedures including, for example performing measurements and generating associated measurement reports (e.g., time difference of arrival and/or the like) in respect of SRS from UEs. The positioning module 67 may communicate (via the communications control module 63) with a positioning function entity in the core network 7 such as the LMF 10-3.

### Sidelink Control Information for SL-PRS

As explained above, sidelink control information (SCI) used for the purposes of assisting scheduling of resources for data (TBs) sent from one UE 3-1, 3-2, 3-4 to another UE 3-1, 3-2, 3-4 on the sidelink may need to include a variety of different types of information. The SCI typically includes, for example, 1st stage SCI that is used by one UE 3-1, 3-2, 3-4 to inform another UE 3-1, 3-2, 3-4 of the resources allocated by the base station 5 for a particular DG/CG period in the network managed mode, or autonomously selected by the UE 3-1, 3-2, 3-4 in the autonomous selection mode. The SCI also typically includes, for example, 2nd stage SCI that carries information used for decoding the PSSCH and for supporting HARQ feedback and CSI reporting or the like.

The 1st stage SCI may typically include, for example frequency resources (e.g., sub-channels) of the PSSCH, a resource reservation for up to two further retransmissions of a TB, information identifying a priority of the associated PSSCH, a format and size of the 2nd-stage SCI, and an MCS of the data payload carried in the associated PSSCH.

Beneficially, the communication system implements an SL-PRS specific SCI design for providing information in support of resource scheduling for SL-PRS that has the potential to provide signalling efficiencies. Specifically, the SL-PRS specific SCI design is based on the recognition that at least some of the information identifying frequency resources (e.g., sub-channels) of the PSSCH typically used in scheduling for of resources for data (TBs) may not be needed. Similarly, at least some of the resource reservation information may not be needed, the priority information is probably not needed, and the format and size of the 2nd-stage SCI may not be needed. The MCS of the data payload carried in the associated PSSCH is also not particularly relevant for SL-PRS scheduling. On the other hand, there may be SL-PRS related information that, if provided, can provide improvements in the resource selection (e.g., in efficiency, signalling overhead, or the like).

There are different possible ways in which the SL-PRS specific SCI design may be implemented, and it is possible for a number of different SL-PRS specific SCI design variations to be configurable, depending on the specific requirements of a given scenario, at the UE 3-1, 3-2, 3-4.

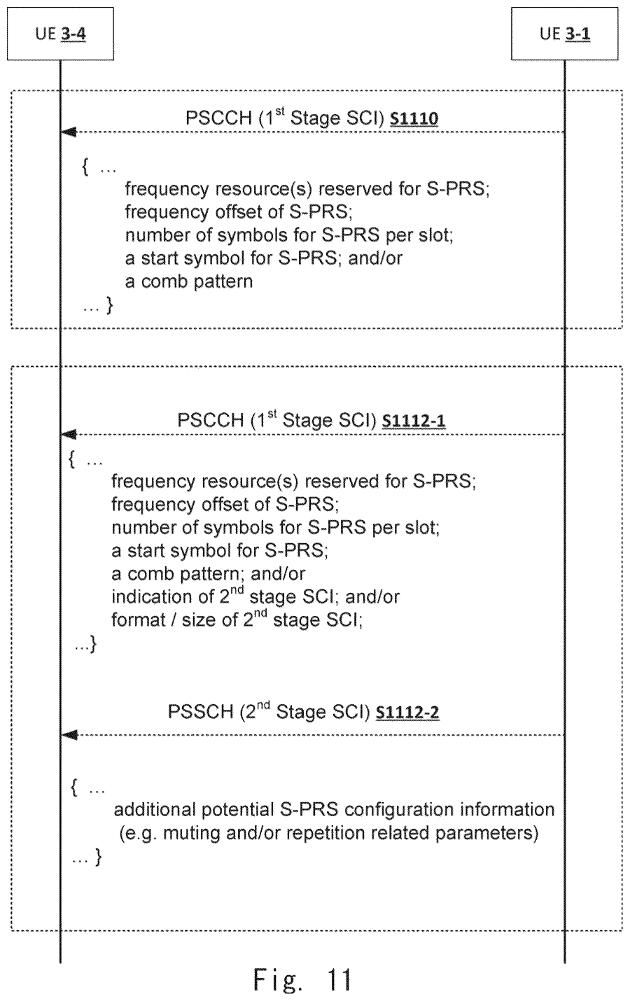

A number of possible SL-PRS specific SCI design implementations will now be described, by way of example only, with reference to FIGS. 11 to 13.

FIG. 11 is a simplified sequence diagram illustrating the transfer of sidelink control information between two UEs in the communication system 1.

As seen in FIG. 11, in one SL-PRS specific SCI design variation, a UE 3-1 provides 1^{st} stage SCI (as seen at S1110) without additional 2^{nd} stage SCI being provided (or needed). Provision of SL-PRS specific SCI in this manner is possible because two stage SCI is not necessarily needed since, for a dedicated S-PRS resource pool, only S-PRS may be transmitted, and data traffic will not be transmitted. It will be appreciated that this SL-PRS specific SCI design variation may be applicable both to network configured resource allocation (mode 1) and preconfigured/autonomous resource (mode 2).

In this example, the 1^{st} stage SCI will typically include information indicating: frequency resources (e.g., sub-channels) reserved specifically for SL-PRS; a frequency offset of the SL-PRS; a number of symbols for the SL-PRS (e.g., on a per slot basis); a starting symbol for the SL-PRS; and/or possibly a comb pattern for the SL-PRS. It will appreciated that all, or any part, of the SCI may be provided at a particular time. Moreover, different parts of the SCI may be sent at different times.

As seen in FIG. 11, in another SL-PRS specific SCI design variation, a UE 3-1 provides 1^{st} stage SCI (as seen at S1112-1) with additional 2^{nd} stage SCI being provided (as seen at S1112-2). It will be appreciated that this SL-PRS specific SCI design variation may be applicable both to network configured resource allocation (mode 1) and preconfigured/autonomous resource (mode 2).

In this example, the 1^{st} stage SCI will typically include information indicating: frequency resources (e.g., sub-channels) reserved specifically for SL-PRS; a frequency offset of the SL-PRS; a number of symbols for the SL-PRS (e.g., on a per slot basis); a starting symbol for the SL-PRS; possibly a comb pattern for the SL-PRS; whether 2^{nd} stage SCI is being sent; and/or a format and size of 2^{nd} stage SCI (if 2^{nd} stage SCI is being sent).

The 2nd stage SCI will typically include information indicating: additional potential S-PRS configuration information (e.g., including muting and/or repetition related parameters related to the transmission of SL-PRS).

It will appreciated that all, or any part, of the SCI may be provided at a particular time. Moreover, different parts of the SCI may be sent at different times.

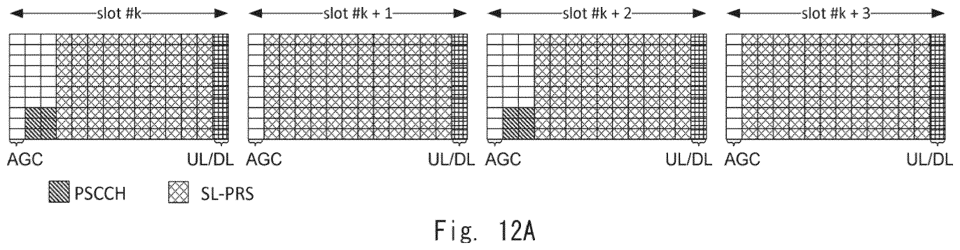

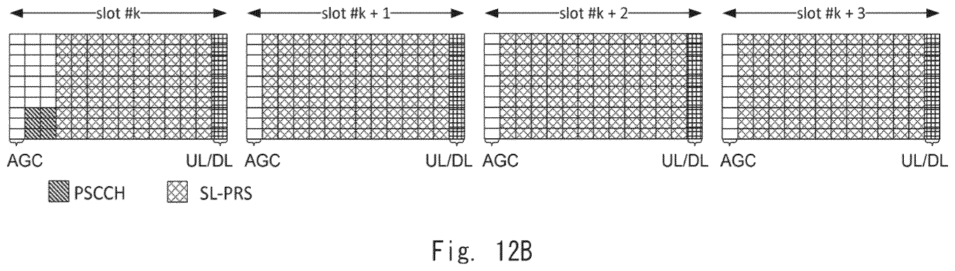

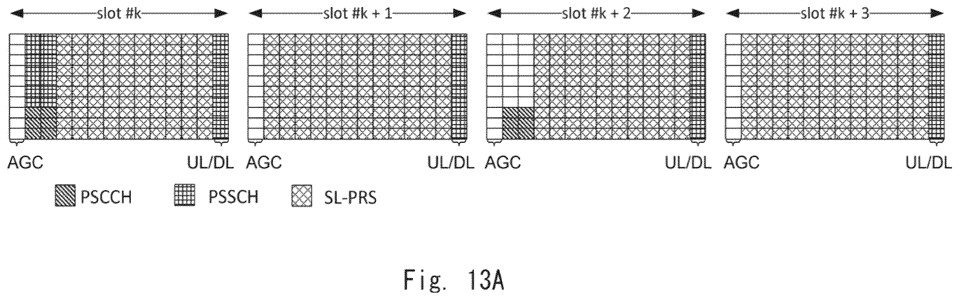

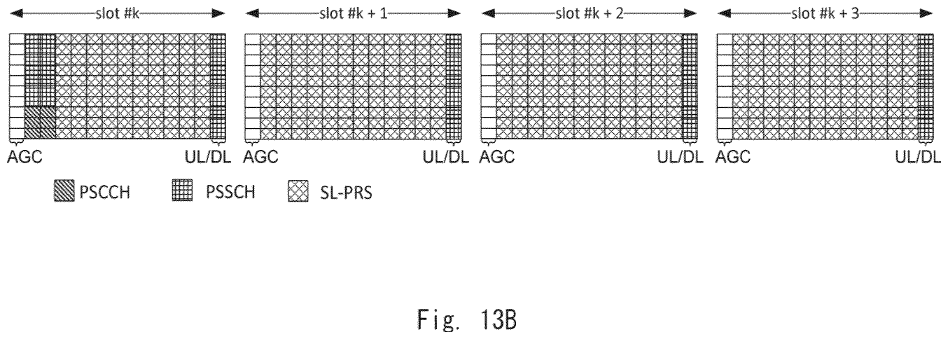

FIGS. 12A and 12B and FIGS. 13A and 13B are each a simplified illustration of a respective way in which sidelink downlink control may be provided in the telecommunication system of FIG. 1.

FIG. 12A illustrates a method in which only 1^{st} stage SCI may be provided, in this example periodically. Specifically, the PSCCH carrying the 1^{st} stage SCI is only transmitted every n^{th} slot (e.g., n=2 in the example but could be another (pre)configured periodicity). In slot 2 therefore, there is no 1^{st} stage SCI.

In this example there is a hypothetical risk that another UE may assume that the resources of a slot that does not include 1^{st} stage SCI are not being used for SL-PRS and may thus select the resources risking collision.

This risk can be avoided by including, in the 1^{st} stage SCI, a periodicity with which the 1^{st} stage SCI will be repeated. Accordingly, another UE can assume that the resources that the 1^{st} stage SCI indicates are reserved/occupied are not released even during a slot when no 1^{st} stage SCI is detected (e.g., slot k+1 and k+3 in the illustrated example).

FIG. 12B illustrates another method in which only 1^{st} stage SCI may be provided, but in this case the 1^{st} stage SCI provides an implicit or explicit activation and/or deactivation indication for an indicated resource configuration and/or a previously configured resource configuration (e.g., indicating when an indicated configuration of specified resources is activated or a previously indicated configuration of specified resources is deactivated). The 1^{st} stage SCI may therefore be transmitted only when a configuration of S-PRS needs to be changed, otherwise, only S-PRS is transmitted (beneficially providing for improved resource utilization). In this case, the UE may attempt to blindly detect 1^{st} stage SCI every slot, and if no SCI is detected, assume that the S-PRS pattern configured by the most recently received SCI continues to be applicable.

In this example there is a hypothetical risk that a collision might happen if a transmitted 1^{st} stage SCI is not detected (e.g., in slot k+1, k+2, k+3). To alleviate this potential issue the UEs may be configured to treat previously configured resources as being in continued use until a deactivation signal is received and the associated resources can be released.

FIG. 13A illustrates a method in which both 1^{st} stage SCI and 2^{nd} stage SCI may be provided, in this example periodically. However, in this example, the periodic 1^{st} stage SCI may be provided with a different periodicity than the periodicity of the 2^{nd} stage SCI (e.g., the 1st stage SCI has a shorter period than the 2^{nd} stage SCI). In the illustrated example the 1^{st} stage SCI is only transmitted every n^{th} slot (e.g., n=2), and the 2^{nd} stage SCI is only transmitted every m^{th} slot (e.g., m=4).

FIG. 13B illustrates another method in which both 1^{st} stage SCI and 2^{nd} stage SCI may be provided, but in this case the 1^{st} stage SCI provides an implicit or explicit activation and/or deactivation indication for an indicated resource configuration and/or a previously configured resource configuration as described. The 1^{st} stage SCI may also indicate whether the 2^{nd} stage SCI is included in a particular slot (and possibly a format/size for the 2^{nd} stage SCI).

### UE SL-PRS Assistance Information

As explained above, for network managed resource allocation (mode 1), the base station 5 can assign a set of sidelink resources to a UE 3-1, 3-2, 3-4 for transmitting several TBs. To support this, the UE 3-1, 3-2, 3-4 may first send a message with UE assistance information to the base station 5 indicating information about the expected sidelink traffic including, for example, a periodicity of TBs, a TB maximum size, and QoS information (e.g., including KPIs, such as the latency and reliability required by the TBs and their priority).

Beneficially, the communication system implements SL-PRS specific UE assistance information design for providing information in support of resource scheduling for SL-PRS that has the potential to provide signalling efficiencies.

Specifically, the SL-PRS specific UE assistance information design is based on the recognition that at least some of the UE assistance information typically used in scheduling for of resources for data (TBs) may not be needed. For example, as TBs may not need to be transmitted at least some of the associated information (e.g., the associated TB periodicity, TB size, and/or associated KPIs) may not be needed. On the other hand, there may be SL-PRS related information that, if provided, can provide improvements in the resource selection (e.g., in efficiency, signalling overhead, or the like).

There are different possible ways in which the UE assistance information design may be implemented, and it is possible for a number of different UE assistance information design variations to be configurable, depending on the specific requirements of a given scenario, at the UE 3-1, 3-2, 3-4.

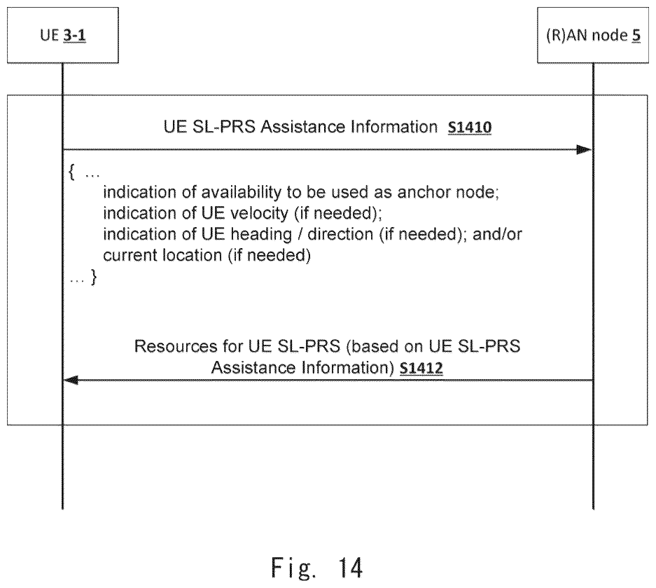

One possible, and particularly beneficial, SL-PRS specific SCI design implementations will now be described, by way of example only, with reference to FIG. 14.

FIG. 14 is a simplified sequence diagram illustrating the transfer of UE assistance information between a UE 3-1 and a base station 5 in the communication system 1.

As seen in FIG. 14, the UE 3-1 provides UE assistance information to the base station 5 (as seen at S1410).

In this example, the UE assistance information typically includes information indicating the sending UE's availability to be used as a so-called ‘anchor’ node (which is a UE relative to which the position of another UE may be determined) for the purposes of positioning. This information is particularly useful as it allows an anchor UE specific SL-PRS resource allocation method to be implemented. The indication of availability to be used as anchor node may be part of a capability inherent to the UE (i.e., part of a UE capability) via a ‘static’ indication (and hence a base station 5 can assume the UE's availability to be used as anchor node remains unchanged). The indication of availability to be used as anchor node may be provided as a dynamic indication or as a semi-static indication.

The UE assistance information may, alternatively or additionally, include mobility and/or location related information such as a UE velocity if necessary, a UE heading or direction if necessary, and/or a current location if necessary. It will appreciated that all, or any part, of this information may be provided at a particular time. Moreover, different parts of the information may be sent at different times.

### SL-PRS Multiplexing

As explained above, in network managed resource allocation (mode 1), the base station 5 may allocate resources for normal data transmission, to a sidelink capable UE 3-1, 3-2, 3-4 and the resources cannot be used by other sidelink capable UEs for their data transmission. In the autonomous mode (mode 2), the UE 3-1, 3-2, 3-4 may exclude candidate resources based on reservations received from other UEs 3-1, 3-2, 3-4 (e.g., in 1^{st}-stage SCIs) detected during a sensing window. In this case, the candidate resources may be excluded as long as the UE 3-1, 3-2, 3-4 has measured an RSRP, associated with the reservation, that is higher than an RSRP threshold. Once a resource block is reserved for normal data transmission, it cannot be used by another UE 3-1, 3-2, 3-4.

Beneficially, the communication system implements resource scheduling/selection methods for SL-PRS that have the potential to provide signalling and/or resource usage efficiencies compared to reuse of the method for normal data transmissions.

The implements resource scheduling/selection methods are based on the recognition that, for SL-PRS transmission, the same resources can be used by more than one UE 3-1, 3-2, 3-4 transmitting S-PRS because the S-PRS can be multiplexed using an appropriate comb pattern.

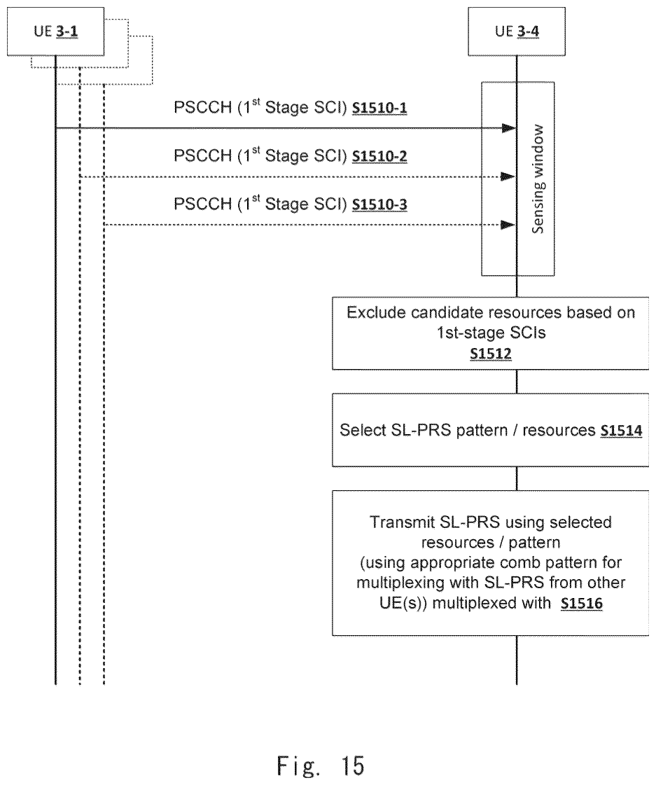

One possible method for autonomous resource selection will now be described, by way of example only, with reference to FIG. 15.

FIG. 15 is a simplified sequence diagram illustrating a method for resource allocation/selection in the communication system 1.

As seen in FIG. 15, during a sensing window the UE 3-4 detects SCIs (at least 1^{st} stage SCIs) from other sidelink capable UEs 3-1 (at S1510-1 to S1510-3). It will be appreciated that SCIs may be received from both UEs that will be transmitting SL-PRS and UEs that will be transmitting normal data (TBs).

During the sensing stage the UE 3-4 will exclude candidate resources based on the reservations received from other UEs 3-1 in the 1^{st}-stage SCIs detected during the sensing window (at S1512). Advantageously, where SL-PRS specific 1^{st}-stage SCI is received (e.g. as described with reference to FIGS. 11 to 13), the UE 3-4 will determine associated information related to the SL-PRS transmission. The associated information may include, for example, a comb size associated with SL-PRS transmission for another UE 3-1, a frequency offset associated with SL-PRS transmission for another UE 3-1, a number of symbols associated with SL-PRS transmission for another UE 3-1. Accordingly, the recipient UE 3-4 will be able to identify if there are any symbols/resource elements left within which to transmit its own SL-PRS.

Beneficially, in this example, measurement of an RSRP threshold in respect of resources reserved for SL-PRS, and the related comparison with a threshold is omitted. In addition to providing for processing and other efficiencies, avoiding this step can help to avoid SL-PRS collision where any RSRP measurement will likely be below the threshold value.

Beneficially, since each UE might use a different respective SL-PRS pattern, a given UE 3-4 may support a plurality of SL-PRS patterns.

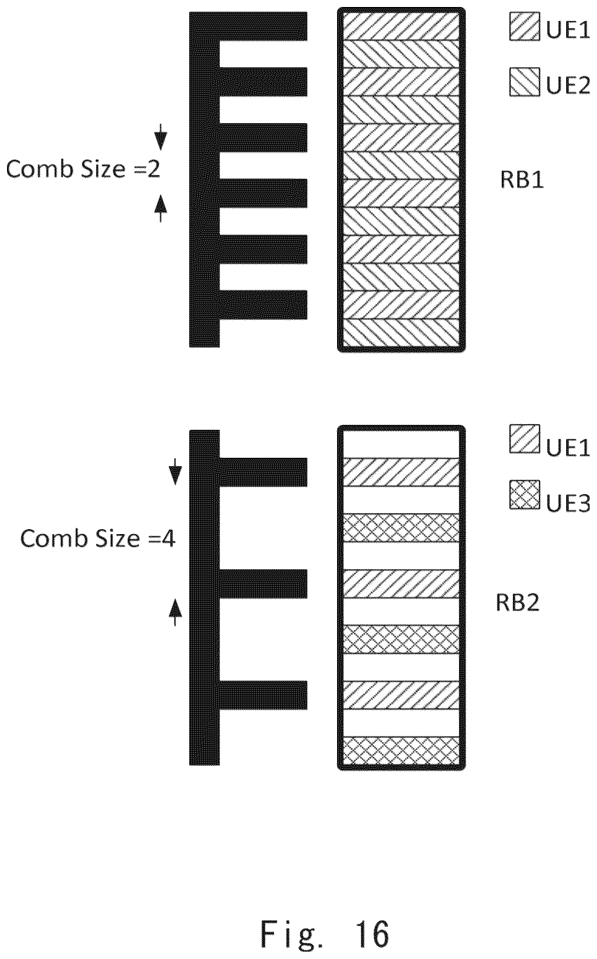

Referring to FIG. 16, for example, which illustrates multiplexing of three different UEs in two resource blocks (RB1 and RB2), a first UE (UE1) is multiplexed with a second UE (UE2), in one resource block (RB1), with a comb size of two. The first UE (UE1) is also shown as being multiplexed with a third UE (UE3), in one resource block (RB1), with a comb size of four. UE1, thus supports two comb sizes—two and four and the two possible associated SL-PRS patterns are deployed in different resources (RBs).

### Joint Resource Allocation/Selection for SL-PRS

As explained above, in network managed resource allocation (mode 1), the base station 5 may allocate resources for normal data transmission, to a sidelink capable UE 3-1, 3-2, 3-4 and the resources cannot be used by other sidelink capable UEs for their data transmission. In the autonomous mode (mode 2), the UE 3-1, 3-2, 3-4 may randomly selects the sidelink resources from the list of available candidate resources (in ‘Step 2’ following exclusion of some candidate resources).

However, while allocation by a based station 5 to a single UE 3-1, 3-2, 3-4 (in mode 1), or random selection in autonomous mode (mode 2), may be suitable for a case where a resource block is used by a single UE 3-1, 3-2, 3-4 this can be inefficient for SL-PRS resource allocation/selection.

Beneficially, therefore, the communication system implements joint/combined resource allocation/selection for SL-PRS for a plurality of UEs. Such joint selection can be particularly efficient for SL-PRS multiplexing scenarios (such as those described with reference to FIG. 16) in which different UEs can share resources of the same one or more resource blocks using an appropriate comb pattern.

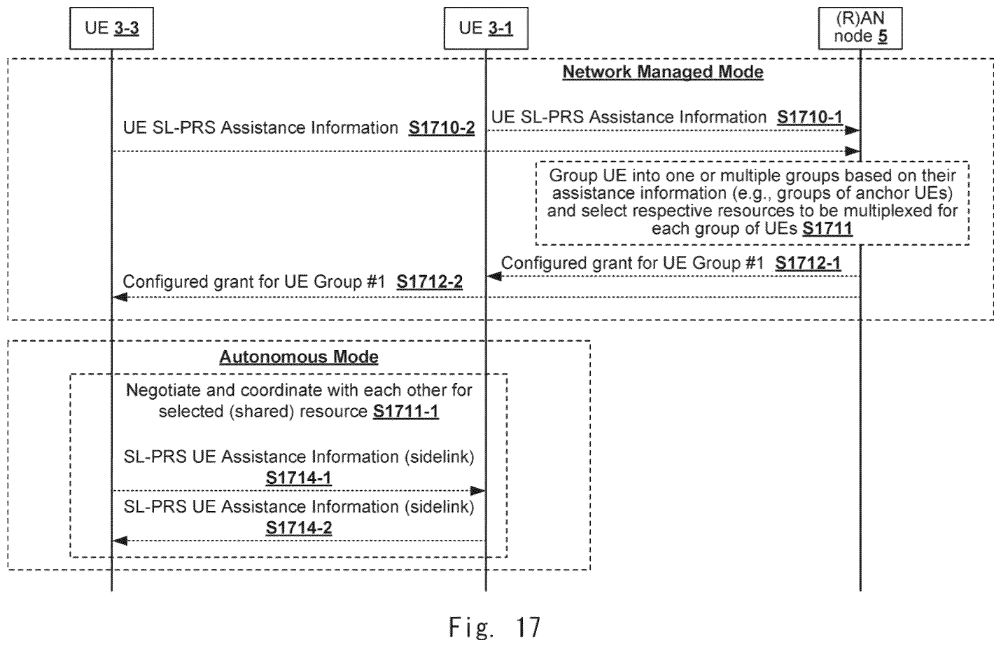

Two methods for joint/combined resource allocation/selection will now be described, by way of example only, with reference to FIG. 17.

FIG. 17 is a simplified sequence diagram illustrating methods for joint resource allocation/selection in the communication system 1.

In the first method joint resource allocation is performed in a network managed mode (mode 1). As seen in FIG. 17, following receipt of appropriate UE specific SL-PRS assistance information from a number of UEs 3-1, 3-3 (e.g., including an indication relating to the UEs' availability to be used as anchor node and/or mobility/location information as described previously) at S1710-1 and S1710-2, the UEs are grouped into one or more groups based on their respective assistance information and selects the respective resources for each group of UEs to use in a multiplexed manner (at S1711). The base station 5 then grants group common resources to the UEs of each group (at S1712-1 and S1712-2).

In the second method joint resource allocation is performed in an autonomous resource selection mode (mode 2). As seen in FIG. 17, in this example, a plurality of UEs negotiate with one another other to coordinate resources to be used, and potentially shared between a group UEs. This negotiation may be based on assistance information shared directly between the UEs in the sidelink (e.g., SL-PRS dedicated UE Assistance Information (sidelink)). For example, a first UE 3-3 may send assistance information to a second UE 3-1 that includes a priority indication (high, low), self-selected resource allocation information, an S-PRS pattern Index, a comb size and/or the like. The second UE 3-1 may respond with its resource selection based on the resource allocation of the first UE 3-3. In case that another UE's resource selection message is received after a UE has sent out its own resource selection, and there is a resource allocation conflict, both UEs may perform a resource re-selection procedure, or the UE with a high priority service may keep its resource selection. If the UEs have the same priority level, the UE with a lower UE identifier may keep its resource selection and one or more other UEs may perform a resource reselection.

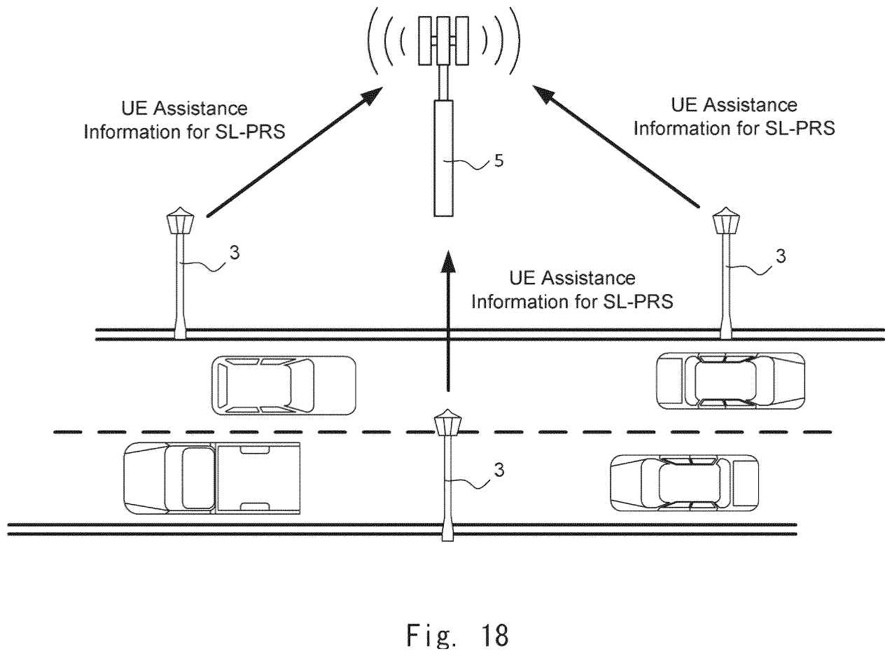

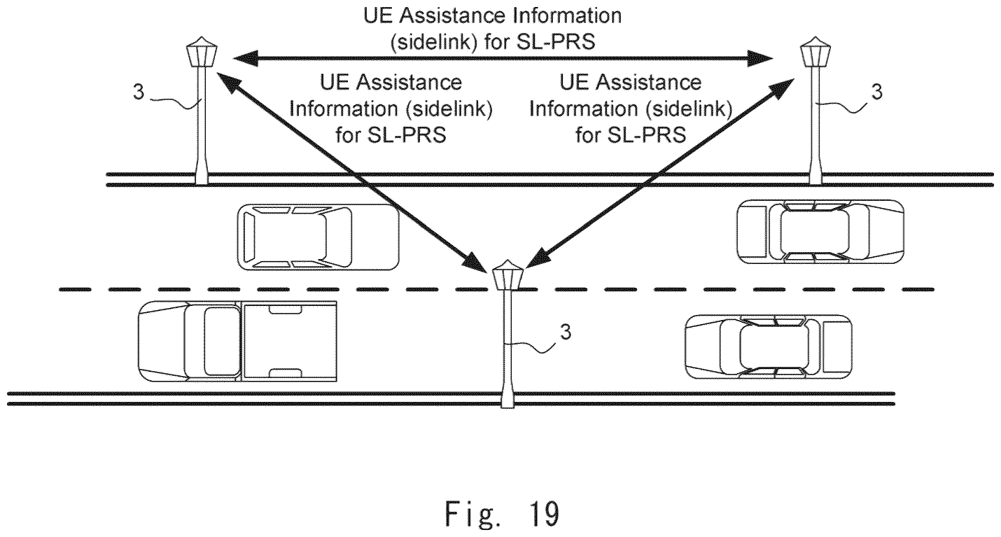

FIG. 18 is a simplified illustration of an application of the network managed method illustrated in FIG. 17 in an exemplary application in which the (anchor) UEs are roadside units (RSUs). FIG. 19 is a simplified illustration of an application of the autonomous method illustrated in FIG. 17 in an exemplary application in which the (anchor) UEs are roadside units (RSUs).

### Modifications and Alternatives

Detailed examples have been described above along with a number of variations and alternatives. As those skilled in the art will appreciate, a number of modifications and alternatives can be made to the above examples whilst still benefiting from the disclosures embodied therein.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part, or all of, this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

| Service Area | MTC applications |
|---|---|
| Security | Surveillance systems |
| | Backup for landline |
| | Control of physical access (e.g., to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

A method performed by a user equipment (UE), the method comprising:
receiving, from another UE, information related to at least one resource configuration for direct UE-to-UE positioning reference signal (PRS) transmission by the another UE;
selecting at least one resource, for transmission of at least one direct UE-to-UE PRS, based on the information; and
transmitting the at least one direct UE-to-UE PRS using the at least one resource.

### (Supplementary Note 2)

The method according to Supplementary Note 1, wherein the information indicates at least one of:
at least one frequency resource reserved for the direct UE-to-UE PRS transmission;
a frequency offset for a resource reserved for the direct UE-to-UE PRS transmission;
a number of symbols, for the direct UE-to-UE PRS transmission, per slot; or a comb pattern for the direct UE-to-UE PRS transmission.

### (Supplementary Note 3)

The method according to Supplementary Note 1 or 2, wherein the information is received periodically in accordance with a periodicity.

### (Supplementary Note 4)

The method according to Supplementary Note 3 wherein the information indicates the periodicity.

### (Supplementary Note 5)

The method according to Supplementary Note 1 or 2, wherein the information is received in a first stage, the information indicates that further information will be transmitted in a second stage, and the method further comprises receiving the further information.

### (Supplementary Note 6)

The method according to Supplementary Note 5, wherein the further information includes at least one parameter related to at least one of: muting, or repetition, to be applied in respect of at least one direct UE-to-UE PRS to be transmitted by the another UE.

### (Supplementary Note 7)

The method according to Supplementary Note 5 or 6, wherein the information is received periodically in accordance with a first periodicity, and the further information is received in accordance with a second periodicity that is different to the first periodicity.

### (Supplementary Note 8)

The method according to any one of Supplementary Notes 1 to 7, wherein the information indicates activation or deactivation of the at least one resource configuration.

### (Supplementary Note 9)

The method according to any one of Supplementary Notes 1 to 8, further comprising communicating with the another UE to identify at least one shared resource for transmission by the UE of at least one direct UE-to-UE PRS that is multiplexed with transmission by the another UE of at least one other direct UE-to-UE PRS.

### (Supplementary Note 10)

A method performed by a user equipment (UE), the method comprising:
transmitting, to an access network node, assistance information for assisting allocation of at least one resource for direct UE-to-UE positioning reference signal (PRS) transmission;
receiving, from the access network node, an allocation of at least one resource for direct UE-to-UE PRS transmission based on the assistance information; and transmitting the at least one direct UE-to-UE PRS using the at least one resource.

### (Supplementary Note 11)

The method according to Supplementary Note 10, wherein the assistance information indicates at least one of:
an availability of the UE to be used as anchor node;
a velocity of the UE;
a heading of the UE; or
a current location of the UE.

### (Supplementary Note 12)

The method according to Supplementary Note 10 or 11, wherein the allocation of at least one resource for direct UE-to-UE PRS transmission is an allocation at least one shared resource for multiplexed transmission of at least one direct UE-to-UE PRS with transmission by another UE of at least one other direct UE-to-UE PRS.

### (Supplementary Note 13)

A method performed by a user equipment (UE), the method comprising:
transmitting, to another UE, information related to at least one resource configuration for direct UE-to-UE positioning reference signal (PRS) transmission by the UE, for selection, by the another UE, of at least one resource for transmission of at least one direct UE-to-UE PRS, based on the information; and
receiving the at least one direct UE-to-UE PRS using the at least one resource.

### (Supplementary Note 14)

A method performed by an access network node, the method comprising: receiving, from a UE, assistance information for assisting allocation of at least
one resource for direct UE-to-UE positioning reference signal (PRS) transmission; and
transmitting, to the UE, an allocation of at least one resource for direct UE-to-UE PRS transmission based on the assistance information.

### (Supplementary Note 15)

A user equipment (UE) comprising:
means for receiving, from another UE, information related to at least one resource configuration for direct UE-to-UE positioning reference signal (PRS) transmission by the another UE;
means for selecting at least one resource, for transmission of at least one direct UE-to-UE PRS, based on the information; and
means for transmitting the at least one direct UE-to-UE PRS using the at least one resource.

### (Supplementary Note 16)

A user equipment (UE) comprising:
means for transmitting, to another UE, information related to at least one resource configuration for direct UE-to-UE positioning reference signal (PRS) transmission by the UE, for selection, by the another UE, of at least one resource for transmission of at least one direct UE-to-UE PRS, based on the information; and means for receiving the at least one direct UE-to-UE PRS using the at least one resource.

### (Supplementary Note 17)

A method performed by an access network node, the method comprising: means for receiving, from a UE, assistance information for assisting allocation of
at least one resource for direct UE-to-UE positioning reference signal (PRS) transmission; and
means for transmitting, to the UE, an allocation of at least one resource for direct UE-to-UE PRS transmission based on the assistance information.

This application is based upon and claims the benefit of priority from Great Britain Patent Application No. 2211854.1, filed on Aug. 12, 2022, the disclosure of which is incorporated herein in its entirety by reference.

### REFERENCE SIGNS LIST

1 mobile (cellular or wireless) telecommunication system
3 user equipment
5 radio access network (RAN) node
7 core network
9 cell
10 control plane functions (CPFs)
10-1 Access and Mobility Management Functions (AMFs)
10-2 Session Management Functions (SMFs)
10-3 Location Management Function (LMFs)
10-n other functions
11 user plane functions (UPFs)
20 external data network
31 transceiver circuit
33 antenna
35 user interface
36 subscriber identity module (SIM)
37 controller
38 UE pre-configuration information
39 memory
41 operating system
43 communications control module
45 direct communications module
47 positioning module
51 transceiver circuit
53 antenna
55 core network interface
57 controller
59 memory
61 operating system
63 communications control module
65 direct communications management module
67 positioning module

What is claimed is:

1-17. (canceled)

18. A method performed by a user equipment (UE), the method comprising:
receiving, from another UE, first stage sidelink control information for indicating at least one time resource related to a dedicated sidelink resource pool for a sidelink positioning reference signal (PRS);
selecting a time resource for the sidelink PRS, based on the first stage sidelink control information and a time resource where the first stage sidelink control information is transmitted, without using second stage sidelink control information; and
transmitting the sidelink PRS using the time resource.

19. The method according to claim 18, further comprising:
transmitting, to the access network node, assistance information for assisting allocation of the time resource for the sidelink PRS; and
receiving, from the access network node, information used for allocation of the time resource for the sidelink PRS based on the assistance information, and wherein the assistance information includes information related to the sidelink PRS.

20. A method performed by a user equipment (UE), the method comprising:
transmitting, to another UE, first stage sidelink control information for indicating at least one time resource related to a dedicated sidelink resource pool for a sidelink positioning reference signal (PRS), for selecting, by the another UE, a time resource for the sidelink PRS, based on the first stage sidelink control information and a time resource where the first stage sidelink control information is transmitted, without using second stage sidelink control information; and
receiving the sidelink PRS using the time resource.

21. A method performed by an access network node, the method comprising:
receiving, from a user equipment (UE), assistance information for assisting determining a time resource for a sidelink positioning reference signal (PRS); and
transmitting, to the UE, information used for determining the time resource for the sidelink PRS based on the assistance information, and
wherein the assistance information includes information related to the sidelink PRS.

22. A user equipment (UE) comprising:
at least one memory storing instructions; and
at least one processor configured to process the instructions to:
receive, from another UE, first stage sidelink control information for indicating at least one time resource related to a dedicated sidelink resource pool for a sidelink positioning reference signal (PRS);
select a time resource, for the sidelink PRS, based on the first stage sidelink control information and a time resource where the first stage sidelink control information is transmitted, without using second stage sidelink control information; and
transmit the sidelink PRS using the time resource.

23. A user equipment (UE) comprising:
at least one memory storing instructions; and
at least one processor configured to process the instructions to:
transmit, to another UE, first stage sidelink control information for indicating at least one time resource related to a dedicated sidelink resource pool for a sidelink positioning reference signal (PRS), for selecting, by the another UE, a time resource for the sidelink PRS, based on the first stage sidelink control information and a time resource where the first stage sidelink control information is transmitted, without using second stage sidelink control information; and
receive the sidelink PRS using the time resource.

24. An access network node comprising:
at least one memory storing instructions; and
at least one processor configured to process the instructions to:
receive, from a user equipment (UE), assistance information for assisting determining a time resource for a sidelink positioning reference signal (PRS); and
transmit, to the UE, information used for determining the time resource for the sidelink PRS based on the assistance information, and
wherein the assistance information includes information related to the sidelink PRS.
